(19) United States
(12) Patent Application Publication
(10) Pub. No.: US 2015/0346345 A1
(43) Pub. Date: Dec. 3, 2015

(54) GLOBAL NAVIGATION SYSTEMS ANTENNA

(71) Applicant: Ohio University, Athens, OH (US)

(72) Inventor: Chris Bartone, Athens, OH (US)

(21) Appl. No.: 14/345,748

(22) PCT Filed: Sep. 19, 2012
(86) PCT No.: PCT/US12/56139

§ 371 Date: Mar. 19, 2014

Related U.S. Application Data
(60) Provisional application No. 61/536,282, filed on Sep. 19, 2011.

(51) Int. Cl. G01S 19/21; H01Q 3/24; H01Q 3/26; H01Q 21/06

(52) U.S. Cl. CPC G01S 19/21; H01Q 21/061; H01Q 3/24; H01Q 3/2617

(57) ABSTRACT

A phased array antenna that can be utilized in one or multiple Global Navigation Satellite Systems. This type of GNSS phased array antenna is often referred to as a CRPA. Various C-Band CRPA embodiments are illustrated to provide advanced performance in a compact real estate size that may fit within L-Band GPS ARINC and L-Band GPS 7-element CRPA size. A Large L-Band CRPA embodiment of the present invention provides for a substantial number of degrees of freedom that can be utilized to provide for advanced beam steering and null steering for advanced interference and multipath mitigation to form nulls over specific geographic regions.

This application claims the benefit of U.S. Provisional Application No. 61/536,282, filed on Sep. 19, 2011, which is hereby incorporated by reference in its entirety.

### BACKGROUND AND SUMMARY OF THE INVENTION

A Global Navigation Satellite System (GNSS) typically utilized space-based ranging sources to determine the position, velocity, and/or timing for a suitably equipped user. The suitably equipped user will typically have a GNSS antenna and receiver combination to process the GNSS signals in space to provide a user with a position, velocity, and/or timing solution. GNSSs include satellite-based navigation systems including the Global Positioning System (GPS), the GLObal NAvigation Satellite System (GLONASS), the Galileo, the Compass/Beidou, Quasi-Zenith Satellite System (QZSS) Navigation Service, the Indian Regional Navigation Satellite System (IRNSS), and similar systems.

Most GNSS receiver systems use a single antenna to receive the GNSS signals. A very limited number of GNSS receivers systems will use multiple antenna elements to process the GNSS signals. Of these multi-antenna GNSS antenna/receiver systems, known configurations contained a limited number of antenna elements to process a limited number of interference sources. Most notable is the 7-element controlled reception pattern antenna (CRPA) used in GPS applications.

Exemplary embodiments of the present invention relate generally to antenna systems. More particularly, an exemplary embodiment relates to an antenna that may be used for a GNSS. Exemplary embodiments may be particularly useful in the C-band and the L-Band, although uses in other frequency ranges may be possible for other GNSSs.

A C-Band based GNSS has been contemplated for many years and more recently as a band of interest for future GNSS. A C-Band GNSS may have advantages and some disadvantages when compared to a comparable L-band GNSS. Most notably, a need exists for a C-Band GNSS that could be positioned within the 5 GHz aeronautical radionavigation service (ARNS) band, with sufficient bandwidth to provide a high-rate pseudorandom (PRN) ranging code.

The 5 GHz carrier frequency is a factor of approximately 3.2 times higher than the GNSS L1 1575.42 MHz carrier frequency, which has some distinct advantages over the GNSS L1 frequency for some embodiments. Firstly, the ionosphere error will be much less. Secondly, the higher rate carrier may produce a composite signal where the direct and indirect signals (i.e., multipath) may vary at a much higher rate, which is expected to produce much less carrier multipath as well as code multipath in an advanced receiver that uses carrier-aided-code tracking. Disadvantages of some embodiments may include increased transmission medium losses in the atmosphere, which may be a factor in heavy rain, as well as, in an indoor environment due to the constitutive (i.e., conductivity, permittivity, and permeability) properties of indoor construction materials (i.e., drywall, wood, etc.). Many of these advantages and disadvantages may be known; however, one critical configuration item that was not concentrated on in previous C-Band GNSS studies is the antenna configurations for a C-Band GNSS, and in particular the user antenna configurations. Exemplary embodiments of the present invention may address this need.

While a C-Band GNSS antenna may have particular benefits for some applications, a need also exists for an improved L-Band GNSS antenna. For example, there is a need for a “large” CRPA for L-Band GNSS use to provide robust performance for high value GNSS platforms.

While most GNSS receiver antennas are relatively small, high value military users often equip with a 7-element CRPA that has a 14″ diameter. With this size of GNSS antenna elements in mind, it is enlightening to reflect on the relatively large size of other communication, navigation, and surveillance antenna systems in use today. For example, large antenna arrays are very common in high performance radar systems used in military and civil aviation applications. Mobile communication base station towers have relatively large phased array antennas to provide frequency isolation over geographic areas and have beamforming networks to allow base stations to pinpoint individual handsets or sectors to increase network capacity. In addition, some large antenna arrays have been seen in high performance navigation ground reference systems for static pattern control to mitigate low rate multipath. Other uses are also possible. Yet a need remains for an improved L-Band GNSS antenna for these and other applications. Exemplary embodiments may satisfy this need.

In addition to the novel features and advantages mentioned above, other benefits will be readily apparent from the following descriptions of the drawings and exemplary embodiments.

### BRIEF DESCRIPTION OF THE DRAWINGS

FIG. 1 is an exemplary embodiment of an ARINC footprint with a 9-element C-Band CRPA configuration (footprint from (ARINC 2001)).

FIG. 2 illustrates a generic side edge view of an exemplary embodiment of a CRPA.

FIG. 3 is an exemplary embodiment of a military FRPA crossed dipole configuration (NAVSTAR GPS UE 1996).

FIG. 4 is an exemplary embodiment of a military FRPA square footprint with a 9-element C-Band CRPA configuration.

FIG. 5 is an exemplary embodiment of a military FRPA spiral helix configuration (NAVSTAR GPS UE 1996).

FIG. 6 is an exemplary embodiment of a military FRPA round footprint with a 9-element C-Band CRPA configuration.

FIG. 7 is an exemplary embodiment of a military FRPA round footprint with a 19-element C-Band CRPA configuration.

FIG. 8 is an exemplary embodiment of a military CRPA 14″ diameter round footprint with a 91-element C-Band CRPA configuration.

FIG. 9 is an exemplary embodiment of directivity and interference mitigation capability as a function of the number of elements in a planar array.

FIG. 10 is an exemplary embodiment of an elevation array factor pattern of a 7 and a 91-element CRPA in a desired signal plane.

FIG. 11 is an exemplary embodiment of an azimuth array factor pattern of a 7 and a 91-element CRPA in an interference/jammer signals plane.

FIG. 12 is an exemplary embodiment of a 3D array factor pattern projection onto the upper hemisphere for a 7-element CRPA with a view angle in the direction of the desired signal.

FIG. 13 is an exemplary embodiment of a 3D array factor pattern projection onto the upper hemisphere for a 91-element CRPA with a view angle in the direction of the desired signal.

FIG. 14 is an exemplary embodiment of a 2D array factor pattern projection onto a local level plane from the upper hemisphere for a 7-element CRPA.

FIG. 15 is an exemplary embodiment of a 2D array factor pattern projection onto a local level plane from the upper hemisphere for a 91-element CRPA.

FIG. 16 is an exemplary embodiment of SINR values for a 7-element CRPA.

FIG. 17 is an exemplary embodiment of SINR values for a 91-element CRPA.

FIG. 18 is an exemplary embodiment of a 127-element L-Band CRPA configuration.

FIG. 19 is an exemplary embodiment of directivity and interference mitigation capability as a function of the number of elements in a 2D planar array.

FIG. 20 is an exemplary embodiment of an elevation array factor pattern of a 127 and a 7-element CRPA in a desired signal plane (e.g., desired signal elevation angle=90°).

FIG. 21a is an exemplary embodiment of a 3D array factor pattern of a 7-element CRPA with a desired signal S_{d}(θ,φ)=[10,90] (e.g., desired signal elevation angle=80°) at view angle: [θ=70, φ=10].

FIG. 21b is an exemplary embodiment of a 3D array factor pattern of a 127-element CRPA with a desired signal S_{d}(θ,φ)=[10,90] (e.g., desired signal elevation angle=80°) at view angle: [θ=70, φ=10].

FIG. 22 is an exemplary embodiment of an elevation array factor pattern of a 127 and a 7-element CRPA in a desired signal plane (e.g., desired signal elevation angle=60°).

FIG. 23a is an exemplary embodiment of a 3D array factor pattern of a 7-element CRPA with a desired signal S_{d}(θ,φ)=[30,90] (e.g., desired signal elevation angle=60°) at view angle: [θ=70, φ=35].

FIG. 23b is an exemplary embodiment of a 3D array factor pattern of a 127-element CRPA with a desired signal S_{d}(θ,φ)=[30,90] (e.g., desired signal elevation angle=60°) at view angle: [θ=70, φ=35].

FIG. 24a is an exemplary embodiment of a 3D array factor pattern of a 7-element CRPA projection onto the upper hemisphere with a desired signal S_{d}(θ,φ)=[30,90] (e.g., desired signal elevation angle=60°) at view angle: [θ=0] (top view).

FIG. 24b is an exemplary embodiment of a 3D array factor pattern of a 127-element CRPA projection onto the upper hemisphere with a desired signal S_{d}(θ,φ)=[30,90] (e.g., desired signal elevation angle=60°) at view angle: [θ=0] (top view).

FIG. 25 is an exemplary embodiment of an elevation array factor pattern of a 127 and a 7-element CRPA in a desired signal plane (e.g., desired signal elevation angle=30°).

FIG. 26a is an exemplary embodiment of a 3D array factor pattern projection onto the upper hemisphere for a 7-element CRPA with a view angle in the direction of the desired signal, S_{d}(θ,φ)=[60,90] (e.g., desired signal elevation angle=) 30° with 5 interference/jammers.

FIG. 26b is an exemplary embodiment of a 3D array factor pattern projection onto the upper hemisphere for a 127-element CRPA with a view angle in the direction of the desired signal, S_{d}(θ,φ)=[60,90] (e.g., desired signal elevation angle=) 30° with 5 interference/jammers.

FIG. 27 is an exemplary embodiment of a 2D elevation array factor pattern of a 7 and a 127-element CRPA in a desired signal direction and an interference/jammer J₁ plane (e.g., φ=90, direction of the desired signal, S_{d}(θ,φ)=[60,90], desired signal elevation angle=30°) with 5 interference/jammers.

FIG. 28 is an exemplary embodiment of SINR values for a 7-element CRPA with 5 interference/jammer sources.

FIG. 29 is an exemplary embodiment of SINR values for a 127-element CRPA with 5 interference/jammer sources.

### DETAILED DESCRIPTION OF EXEMPLARY EMBODIMENT(S)

Exemplary embodiments of the present invention are directed to GNSS antennas. One such embodiment may be adapted to operate most effectively in the C-band, whereas another exemplary embodiment may be adapted to operate in the L-Band. Exemplary embodiments of C-Band and L-Band antennas are addressed in detail herein. Nonetheless, one skilled in the art will recognize that exemplary embodiments may be adapted to operate at other frequencies including, but not limited to, 2.4 GHz or other suitable frequencies for GNSSs.

### Exemplary Embodiments of C-Band Antennas

Various exemplary antenna configurations such as for a C-Band GNSS are addressed herein. While several aspects of a GNSS space vehicle (SV) antenna are addressed, these aspects will be defined to help assess the performance aspects of the various user antenna configurations for a C-Band GNSS. For example, several user antenna configurations will be considered including: 1) the ARINC sized footprint that is commonly used on many commercial aviation aircraft; 2) a fixed reception pattern antenna (FRPA) that has been used on many military aircraft; and 3) CRPA found on many military aircraft. Nonetheless, the design principles discussed herein may be adapted to other user configurations that are now known or may be later developed. All configurations considered will be based upon a phased antenna array. For the purpose of testing a C-Band GNSS, a GPS L1 link was used as a baseline configuration under constant SV transmitter power, antenna gain, and similar link loss assumptions to show that the power density prior to the user antenna is the same for an exemplary C-Band GNSS as compared to a comparable L-band GNSS. Additionally, if the user antenna has the same effective aperture size, then the same received power at the antenna output may be obtained. With respect to one exemplary embodiment, the inventors discovered that if the real estate (i.e., footprint of existing L-Band user antennas) is maintained (and not allowed to decrease as the frequency increases from L to C-Band), an exemplary C-Band CRPA may be implemented in the same size as an L-Band FRPA. Other exemplary embodiments may use, for example, different FRPA footprints and the common 14″ diameter CRPA footprint configuration. The inventors made the significant discovery that while the power received for an exemplary C-Band GNSS may be similar, the increased frequency may, for example, enable CRPAs to be implemented in existing L-Band FRPA footprints allowing for interference/jamming and both carrier and code phase multipath mitigation. Also, for an example of military platforms that currently have a 14″ diameter L-Band CRPA installed, the inventors discovered that a 91-element C-Band CRPA may be accommodated and may provide increased directivity that may be utilized for increased interference/jamming and both carrier and code phase multipath mitigation.

### Power Received for an Exemplary C-Band GNSS

### Baseline: An L1-Band GPS

For the purpose of this example, the inventors considered a transmitter transmitting a signal with Pₜ Watts (W) from an isotropic transmitter. In this test, the signal was considered to be transmitted uniformly in all directions over the surface area of a sphere (4πR²); hence, the power density, W₁₀ at a distance R, could be expressed as shown in equation (1). The power density received at a distance R is not a function of frequency.

$$\begin{matrix}{W}_{t 0} = Power Density Received from an Isotropic Souce \\ = {P}_{t} ( \frac{1}{4 π {R}^{2}} ) , [ \frac{W}{{m}^{2}} ]\end{matrix} \\ where \text{:} \\ {P}_{t} = Transmitter Power , [ W ] \qquad ( 1 )$$

Next, the inventors considered the baseline GPS L1 link. The inventors allowed for a nominal transmitter power (i.e., Pₜ=22 W) and transmitter antenna gain of Gₜ of 13 dBic (dB relative to an isotropic radiator for circular polarization). Known GPS SV transmission antennas may provide for good Earth coverage (with a small gain dip in the middle) with some beyond the edge of Earth coverage depending upon GPS Block type. Furthermore, a known GPS transmission antenna is approximately 1 meter (m) in diameter. While the exact shape of the antenna radiation pattern was not critical for this analysis, it was assumed to be the same for the analysis of an exemplary C-Band link. The inventors allowed for a nominal orbital radius of the GPS SV, (i.e., R=22,000 km), such that the power density, at the face of the reception antenna may be as shown in equation (2).

$$\begin{matrix}{W}_{t} = Power Density Received from a directional source \\ = {P}_{t} {G}_{t} ( \frac{1}{4 π {R}^{2}} ) , [ \frac{W}{{m}^{2}} ]\end{matrix} \\ where \text{:} \\ {P}_{t} = SV Transmitter Power , [ W ] \\ {G}_{t} = SV Transmission Antenna Gain , [ dBic ] \qquad ( 2 )$$

Equation (2) expresses the power density of the GPS signal at the input face of the user antenna. The power received by the antenna is a product of this power density. The receiver antenna aperture is expressed in equation (3).

$$\begin{matrix}{P}_{r} = {W}_{t} {A}_{r} \\ = Power Received ( at atenna output ) \\ = {}_{t} ( \frac{{P}_{t} G}{4 π {R}^{2}} ) {G}_{r} ( \frac{{λ}^{2}}{4 π} ) , [ \frac{W}{{m}^{2}} ] \\ = {P}_{t} {{GG}_{r} ( \frac{λ}{4 π R} )}^{2}\end{matrix} \\ where \text{:} \\ {P}_{t} = SV Transmitter Power , [ W ] \\ {G}_{t} = SV Tranmission Antenna Gain , [ dBic ] \\ {A}_{r} = Receiver Antenna Aperture = {G}_{r} ( \frac{{λ}^{2}}{4 π} ) , [ {m}^{2} ] \qquad ( 3 )$$

For this analysis of exemplary C-Band antenna configurations, it is important to note that the received power is a function of the power density and the received antenna aperture.

### Assumptions and Constraints: From a GPS L1 to GNSS C-Band Configuration

Using the GPS L1 configuration as baseline for comparison, the inventors used a set of assumptions and constraints for the C-Band GNSS link analysis. First, the inventors let the transmitted power for the C-Band GNSS system be exactly the same as the L-Band GPS transmitter power (i.e., Pₜ=22 W). Second, the inventors let a C-Band GNSS have the same antenna gain and Earth coverage as the known L-band GPS systems (i.e., Gₜ=13 dBic). Under this assumption, this allowed the C-Band GNSS SV transmission antenna to be much smaller than the L-band GNSS antenna. Since antenna aperture is a function of the square of the wavelength, and under a constant gain assumption constraint, if the wavelength decreased by ⅓, then the aperture could decrease by the square of that or 1/9. This allowed a comparable C-Band GNSS SV transmission antenna to be about 1/9 m in diameter, which is a significant improvement.

The next assumption used in the analysis is that the link losses would be the same for a C-Band GNSS as they would be for an L-band GPS. Now, it is true that some of these link loss parameters will get somewhat worse for various media (e.g., attenuation), but they are assumed to be the same as not to lose focus on the key points of this paper. Other parameters such as mismatch and polarization losses are assumed to be the same. Additionally, increased carrier phase noise in the carrier tracking loop is not explicitly considered here but has been addressed elsewhere.

Now, under the constant SV transmission antenna gain, same transmitter power, and link loss assumptions, the power density of the C-Band GNSS signal at the input to the antenna will be exactly the same as it would be for a comparable L-Band GPS. Furthermore, if the receiver antenna aperture remains exactly the same for the C-Band user antenna, as it is for a comparable L-Band user antenna, then the power received at the user antenna output terminals will be exactly the same. This is a very important point since, the Friis transmission equation that is often rearranged in equation (3) often identifies the (λ/4πR)² as “path loss” or “path loss factor”. The λ² factor comes from the aperture expression in the power received, so if the aperture is not allowed to get smaller as the frequency is increased, the power received will be the same. What does change, under a constant aperture constraint as the frequency increases is the directivity (and gain), where the gain is the directivity times the efficiency of the antenna. Thus, under the assumptions and constraints that we have put forward, if we maintain the same size aperture on the user reception antenna, then we will receive exactly the same power for our C-Band GNSS as our L-Band GPS baseline systems, and have the benefit of increased directivity that can be used to increase the performance of our C-Band GNSS as compared to comparable L-Band GNSS.

### Antenna Configurations for a C-Band GNSS

Under the constant gain assumption presented earlier, the C-Band GNSS SV antenna could become smaller than the comparable L-Band GPS SV transmission antenna by a factor of 1/9^{th}. Additionally, the C-Band GNSS SV antenna could be designed more efficiently with the reduced aperture size, integrated with the L-Band, or become part of newer generation C-Band downlink telemetry signal format. Furthermore, the C-Band GNSS SV transmission antenna could be designed with an additional design parameter to minimize the back and sidelobe radiation from the pattern; this would help concentrate additional gain in the direction towards the Earth, which may scavenge some of the radiated power in the back and sidelobes to the antenna main beam directed towards the Earth.

### ARINC User Antenna Configuration

The GNSS user antenna footprint specified in the ARINC GNSS Sensor Characteristic 743A-4 document published Dec. 27, 2001, is widely accepted within the commercial and private aviation community. This ARINC footprint is rectangular in shape with a length of 4.70″ (forward to aft), width of 2.90″ with rounded corners, and four mounting holes with underlying fuselage hole and o-ring specified.

At 5.0 GHz the wavelength is 6.0 cm in length. For all of the antenna configurations, concentration will be on the antenna array factor. Each antenna element is assumed to be a square patch antenna element of size λ/4 by λ/4, which would make each element 1.5 cm×1.5 cm. The spacing between each antenna element is about λ/2 by λ/2 (3.0 cm×3.0 cm). One of ordinary skill in the art would recognize that various antenna element shapes and slight variations in the spacing about some exemplary spacing provided in this and other embodiments, in a square, rectangular, oval, or circular arrangement may be accommodated within scope of the present invention.

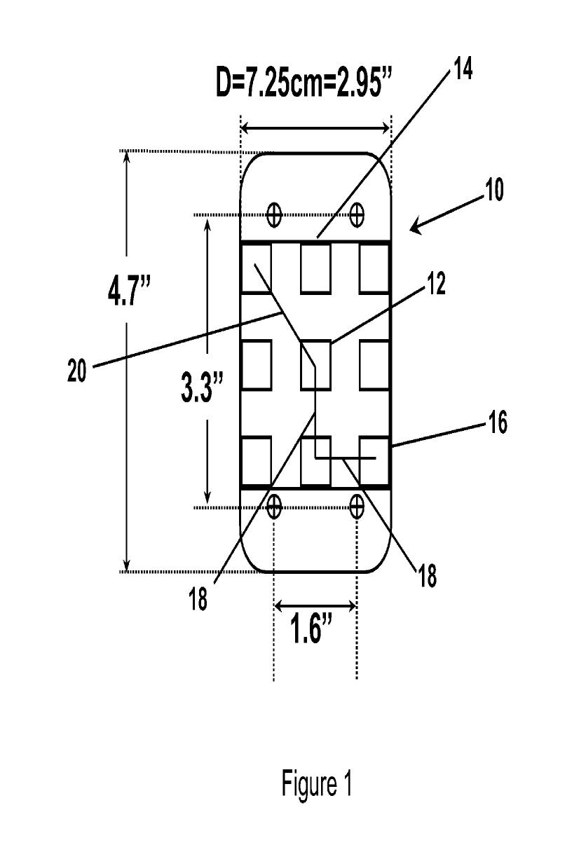

The rectangular shape of the ARINC footprint lends itself naturally to a more square or rectangular antenna array configuration 10 such as shown in FIG. 1. This exemplary embodiment includes 9 antenna elements, namely a center antenna element 12, 4 side antenna elements 14, and 4 corner antenna elements 16. The antenna elements of this example are substantially co-planar. With the element size of λ/4 by λ/4 and element spacing of λ/2 by λ/2 as presented, a 3×3 (i.e., total of 9-element) array factor configuration may easily be accommodated as depicted in FIG. 1. In particular, the centers of the side antenna elements 14 are a first distance 18 from the center of the center antenna element 12, and the centers of the side antenna elements 14 are also a first distance 18 from the respective centers of adjacent corner antenna elements 16. The centers of the corner antenna elements 16 are a second (diagonal) distance 20 (e.g., about 0.707 of a wavelength of the center of the frequency of operation of the antenna in this exemplary embodiment) from the center of the center antenna element 12. The total width (side-to-side) of this exemplary embodiment is λ/8+λ/2+λ/2+λ/8=7.5 cm=2.95″. While this dimension is 0.05″ greater than the 2.90″ specified, the spacing and/or element size and configuration may be slightly altered to confine to the ARINC footprint.

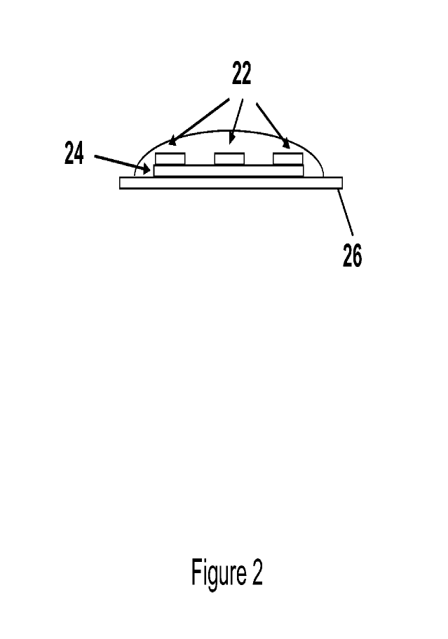

The hole positions within the ARINC footprint complicates additional elements in the side-to-side direction, but two additional elements may be added in the forward-to-aft direction to provide for increased directivity in the starboard and port sides of the aircraft, which may be used in the direction of a desired SV or in the direction of an interference/jammer source. These installed and test configurations would allow the antenna to perform effectively. Installations on composite structures would provide minimal performance variations. While it may not be desirable to place patch elements on the edge of an antenna structure, since they do perform better when supported by a uniform ground plane, the ARINC antenna is typically mounted on a metallic ground plane (i.e., aluminum fuselage body) and is tested with a rather large aluminum curved structure that is intended to be a practical test surface simulating the installed conditions. FIG. 2 illustrates the side/edge view of a generic view of an exemplary CRPA showing the antenna elements 22, dielectric layer 24, and ground plane 26. The size, number, shape, and type of the antenna elements, dielectric layer, and ground plane (with radome) may vary based upon the exemplary embodiments disclosed in this invention, without loss of scope of this invention.

Of significant importance is that a 9-element CRPA may be accommodated within the footprint of a current L-Band GNSS ARINC footprint FRPA. Thus, the effective received aperture of the receiver antenna will be approximately the same and with efficient antenna design, this will allow the received power of the C-Band GNSS signal to be the same (with the assumptions and constraints presented earlier) as a comparable L-Band GNSS. Now the major difference is that the C-Band CRPA GNSS user antenna can now form nulls in the direction of interference and jamming sources. A common term in antenna array design is the degrees of freedom an array has, which is N−1, where N represents the number of elements in the array. (Here the spatial degrees of freedom are illustrated resulting from the number of physical antenna elements, separated in space from one another.) Thus, up to 8 interference/jammer sources may potentially be mitigated with this 9-element C-Band GNSS CRPA antenna within the ARINC footprint. One of ordinary skill in the art would recognize that the number of antenna elements may vary about the exemplary number of elements for this and other exemplary embodiments to accommodate variations in the spacing and/or configuration, such as for a square, rectangular, oval, or circular arrangement within scope of the present invention.

### Military FRPA Configuration

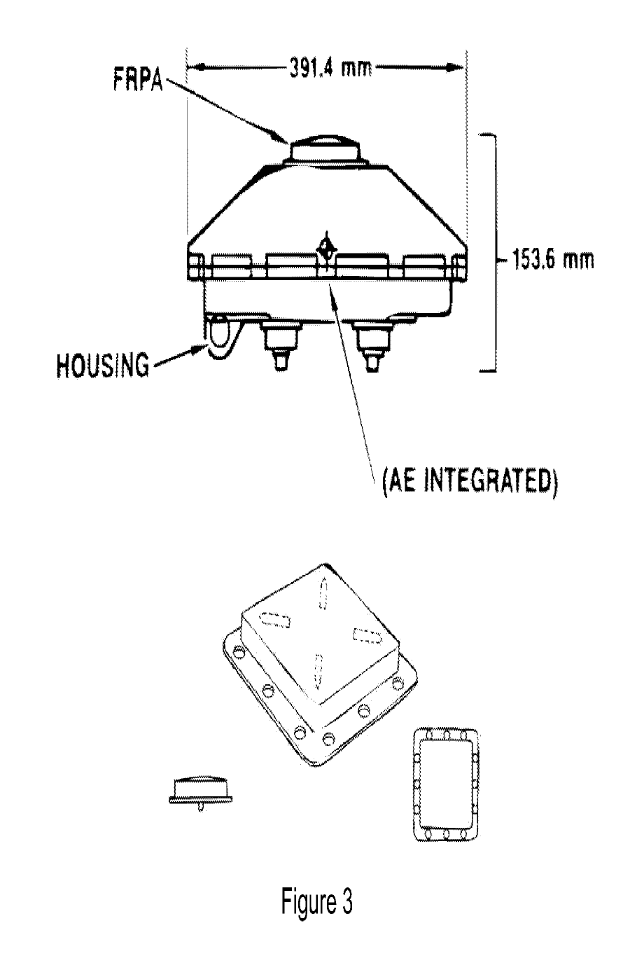

Some military aircraft utilize a FRPA configuration (NAVSTAR GPS UE 1996), which is considered here. FIG. 3 illustrates a known military FRPA with a square crossed dipole antenna element configuration.

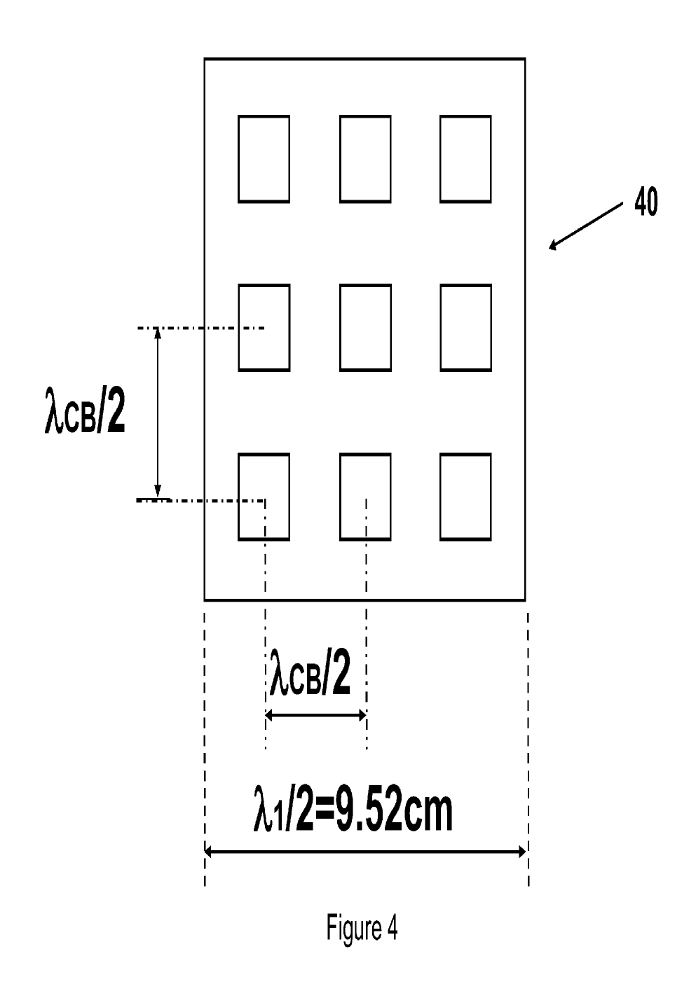

Once again the square FRPA crossed dipole element footprint lends itself well to a square antenna array configuration 40 as shown in FIG. 4. The square area of 11.7 cm×11.7 cm (4.6″×4.6″) may easily accommodate the same 3×3 or 9-element antenna array factor configuration. Once again, λ/4 by λ/4 square patch elements with spacing of λ/2 by λ/2 is used. Again, with efficient antenna array design, the aperture of the square FRPA may be used for a 9-element C-Band CRPA. This CRPA will provide for equivalent received desired signal power as outlined previously and again enable up to 8 interference/jammer sources to be mitigated.

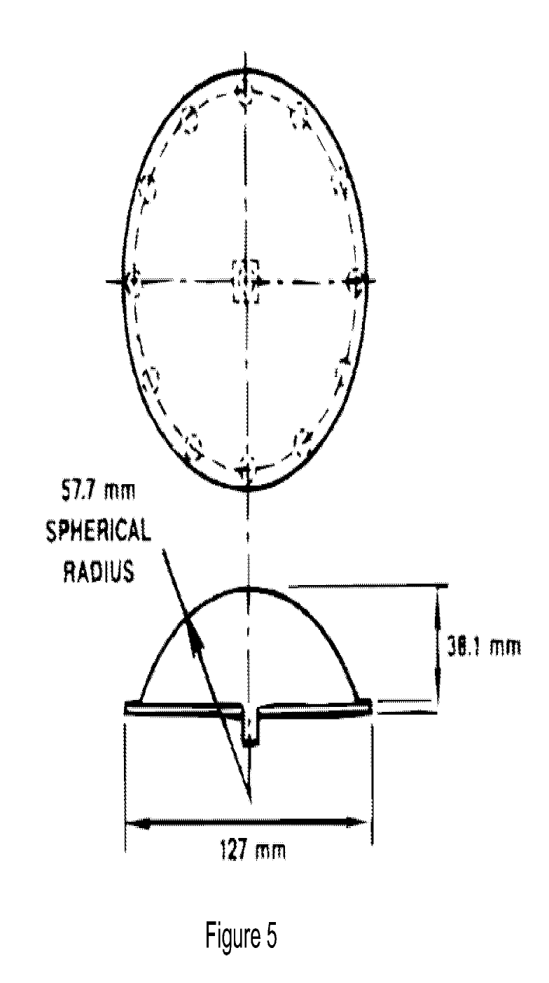

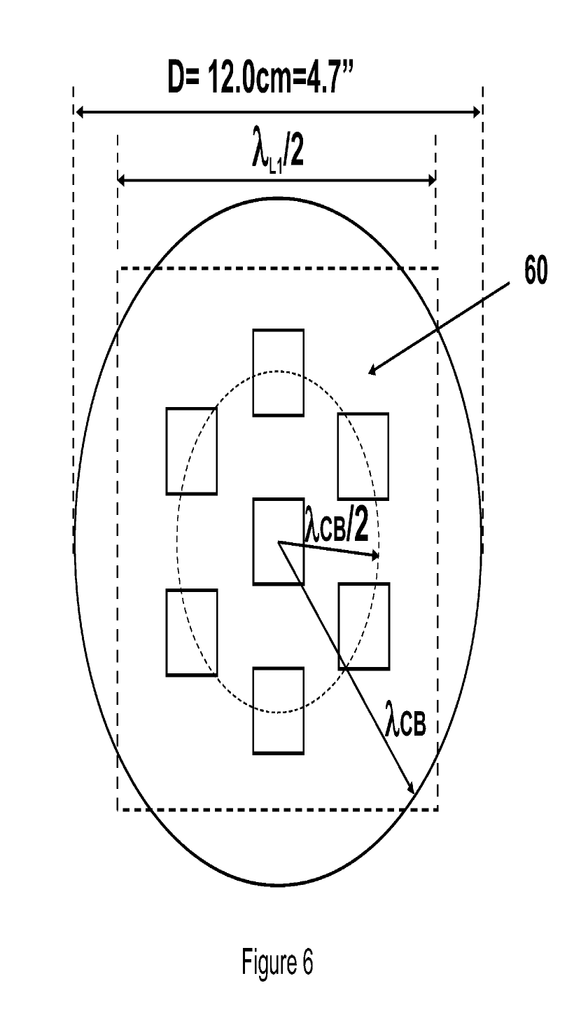

FIG. 5 illustrates an alternative round known FRPA Spiral Helix configuration that measures 12.7 cm×12.7 cm (5.0″×5.0″). This round configuration naturally lends itself to a circular antenna array configuration 60 with a total of 7-element, including a center reference element, see FIG. 6. (This C-Band configuration is similar to a L-band 14″ diameter CRPA.) For the layout of this circular configuration 60, the radius of the ring is considered to be λ/2 (i.e., the distance from the center of the center antenna element to the center of an outer antenna element), which would produce an arc length from element to element slightly greater than λ/2 (i.e., s=rθ, where s=the arc length, r=radius, θ=angle subtended). One of ordinary skill in the art will recognize that the exact radius and arc length may be adjusted within scope of the present invention.

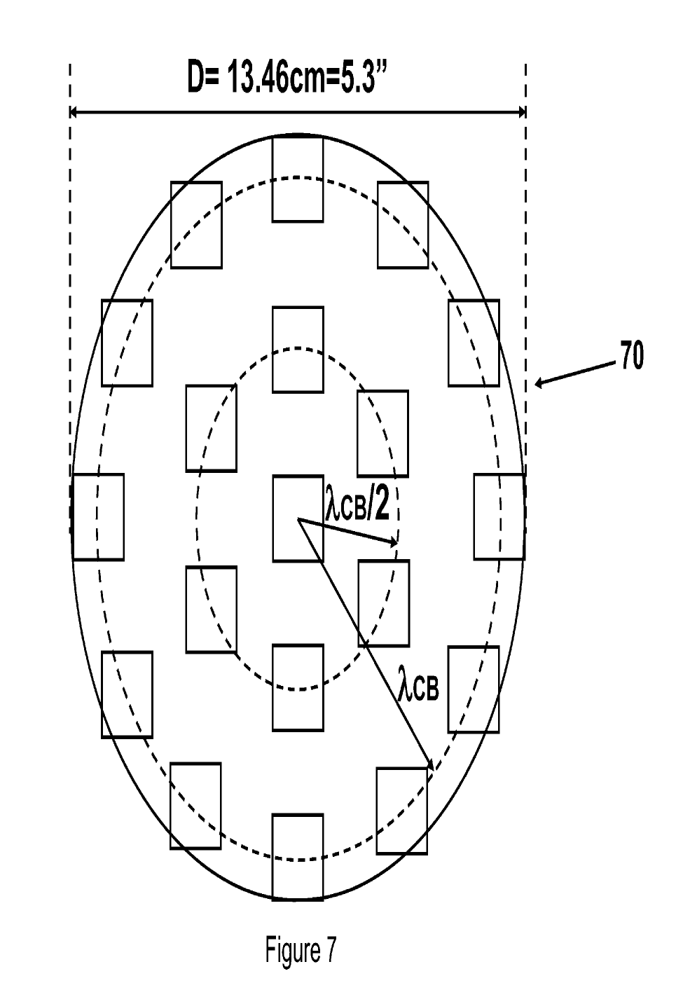

The 7-element C-Band CRPA configuration may easily fit into the round FRPA footprint, and a circle of diameter 2λ_{CB} (CB=C-Band) of 12 cm (4.7″) will fit inside the round 12.7 cm×12.7 cm (5.0″×5.0″) footprint. In another exemplary embodiment, adding another array ring creates an array configuration 70 as shown in FIG. 7, which under the conditions of λ/4 by λ/4 square patch elements with radial spacing of λ/2 produces an array of diameter 13.46 cm (5.3″), which is slightly larger than the diameter 12.7 cm (5.0″) of the round FRPA footprint. An array of this configuration enables a 19-element CRPA to be configured at C-Band. Providing 19 elements in the round 12.7 cm (5.0″) footprint allows for additional ring and performance to be added as the available areas is increased. Decreasing the radial distance space of element, increasing the permeability of the antenna substrate material and decreasing the size of the elements may be employed for this 19-element CRPA C-Band configuration.

### CRPA 14″ Configuration

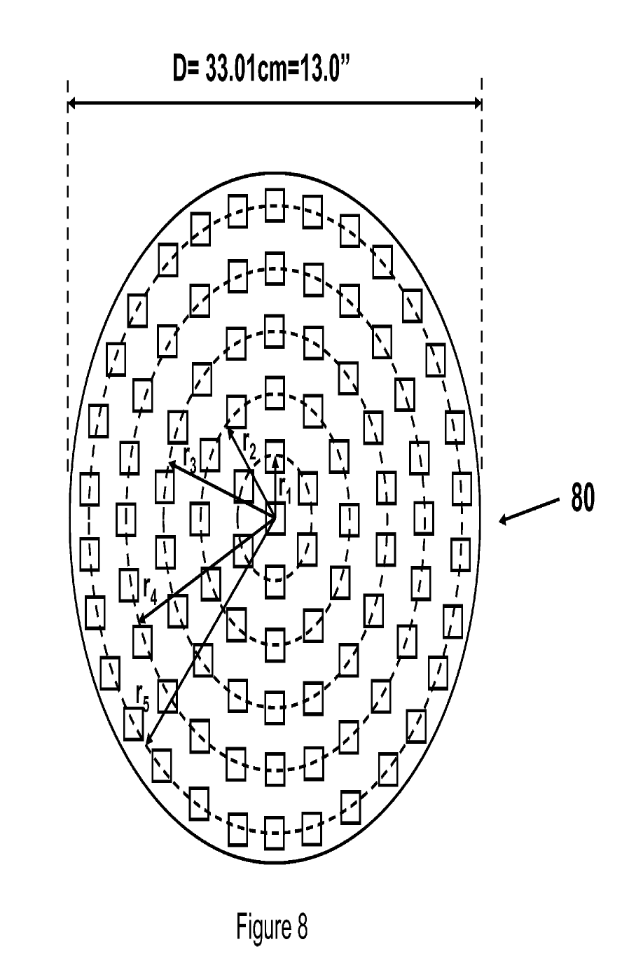

Another exemplary configuration relates to the common 14″ diameter L-Band CRPA found on many military platforms. In this example, of the 14″ diameter, 13″ may be used to populate C-Band antenna elements. A round array configuration with λ/4 by λ/4 square patch elements may be used with radial element spacing, rₙ of nλ/2, where n=the ring number. The number of elements per ring may be represented as Nₙ where n=0, 1, 2, etc, with N again as the total number of elements in the entire array. FIG. 8 illustrates an exemplary embodiment of a C-Band CRPA for the 14″ diameter current L-Band CRPA footprint. This configuration 80 may support 5 rings and a center reference element. The total number of elements in each ring is N₀=1 (center reference element), N₁=6, N₂=12, N₃=18, N₄=24, N₅=30. The number of elements per ring may be based on the radial distance from the center, the desire to keep the arc length close to λ/2 and overall symmetry of the array. The total number of elements in the array is the sum of the number of elements per ring, which can be represented as N=N₀+N₁+N₂+N₃+N₄+N₅=1+6+12+18+24+3φ=91. Thus, in this embodiment, a total of 91 elements may be supported in the 14″ L-Band CRPA footprint for the C-Band CRPA. This allows for up to 90 interference/jammer sources to be mitigated. One of ordinary skill in the art will again recognize that the exact radius and arc length may be adjusted within scope of the present invention.

### Directivity, Jamming and Degrees of Freedom

A FRPA for GNSS applications is usually mounted on a ground plane to provide good upper hemi-sphere coverage in the directions of all possible desired SV signals. A nominal FRPA typically provides for approximately 0 dBic gain at zenith (i.e., 90° elevation angle), and is not able to produce nulls on interference/jammer sources.

As stated earlier, an antenna array with N elements may have N−1 spatial degrees of freedom and may mitigate up to N−1 interference/jammer sources; this is a simple linear relationship, but it should be recognized that advanced signal processing techniques may be implemented to help improve the interference mitigation such as space and time adaptive processing (STAP) or space and frequency adaptive processing (SFAP). The performance of these techniques is often characterized in terms of increasing the total degrees of freedom obtained. These signal processing techniques may be combined with the spatial antenna array techniques presented here. However, it should also be recognized that the actual interference/jamming performance is often dependent upon the interference/jamming characteristics including bandwidth and power. As the power and bandwidth of the interference sources are increased, additional degrees of freedom can be consumed.

One of the major advantages with a C-Band GNSS over an L-Band GNSS is the ability to place a CRPA in the footprint of existing FRPA as well as providing for increase directivity within a giving L-Band CRPA footprint. While the exact directivity would be numerically calculated based on the direction of the main beam and the location of the interference sources, a good approximation for a planar array in a local xy plane is shown in equation (4).

D=πDₓD_{y} cos θ (4)

where:
Dₓ=maximum directivity in the x direction
D_{y}=maximum directivity in the y direction
θ=spherical angle from normal to the planar surface

The directivity naturally falls off at the horizon due to the projection of the incident uniform plane wave onto the array plane, however a finite gain may still exist in final designs due to non-ideal conditions.

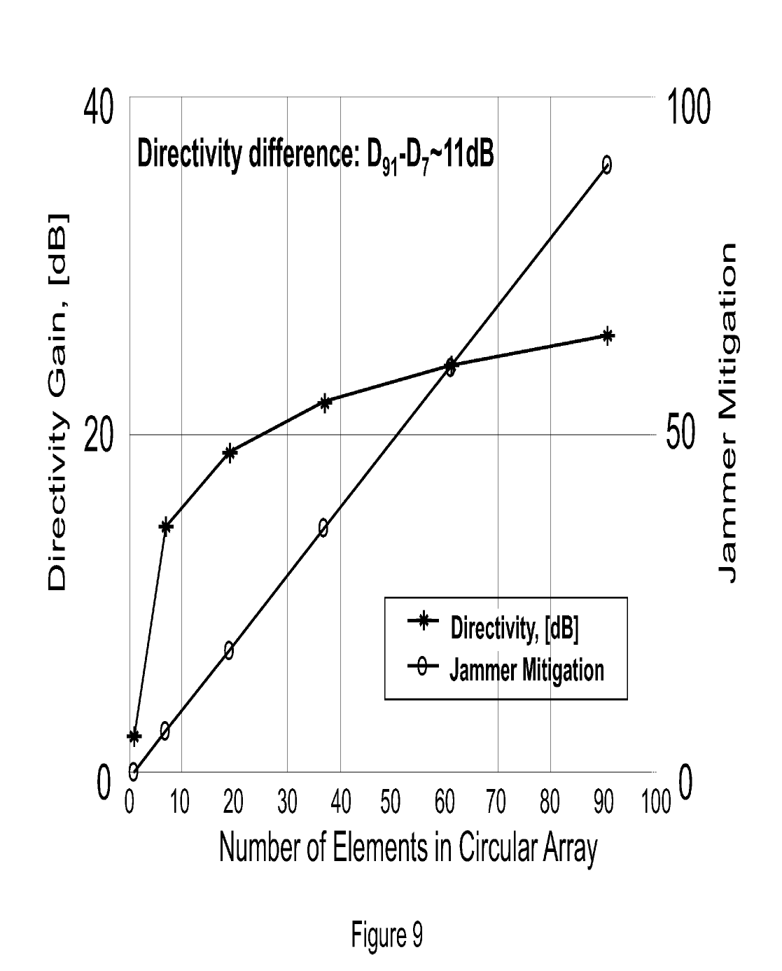

Using Equation (4) the directivity at zenith with uniform illumination of the array was calculated for a various number of elements in a planar array configuration and plotted in FIG. 9 along with the linear number of interference/jammer mitigation capability. An exemplary 7-element CRPA has a theoretical maximum directivity of 14.5 dB at zenith with an interference/jammer mitigation capability of up to 6 sources, while an exemplary 91-element CRPA has a theoretical maximum directivity of 25.8 dB at zenith with an interference/jammer mitigation capability up to 90 sources. Of importance is the ability to provide for up to 8 interference/jamming sources mitigation with the C-Band 9-element CRPA where previously the L-band FRPA had zero. Also, the directivity of the C-band CRPA over the L-band FRPA will provide for decreased multipath on the code and carrier phase measurements due to the increased directivity and reduction in the received signal energy in directions other than that of the desired satellite signal reception angle.

Also of significant importance is the performance of the exemplary 91-element C-Band CRPA as compared to the 7-element L-Band CRPA in the 14″ diameter footprint. The number of interference/jammer sources that may be mitigated grows to 90, up from 6 and the directivity increase is approximately 11 dB. This allows for many more jamming sources to be mitigated and a reduction in code and carrier multipath by having a much more directive main beam pointed in the direction of the desired signal while minimizing the signal energy received at other angles where multipath may come into the antenna.

### C-Band Array Factor and Illustrated Performance

To illustrate the performance of the exemplary C-Band CRPA, various circular planar antenna array factor configurations were simulated in Matlab. For these simulations neither the individual antenna element patterns nor any potential mutual coupling between each element were simulated. For these simulations, a receiver architecture was assumed that would perform digital beam forming in a minimum variance (MV) distortion-less response (MVDR) fashion such that the main beam would be pointed in the direction of the desired signal with the antenna steering weights constrained so that the desires signal would not be distorted. This MVDR processing would support a digital receiver architecture such that each receiver channel would receive the digital data that was processed by the antenna steering algorithm considering the directions of the desired signal (i.e., GNSS SV direction) and undesired signal directions (e.g., interference/jamming sources). The MVDR antenna steering weights are calculated as shown in equation (5).

$${w}_{MV} = \frac{{R}_{uu}^{- 1} {a}_{0} ( {θ}_{0} , {φ}_{0} )}{{a}_{0}^{H} ( {θ}_{0} , {φ}_{0} ) {R}_{uu}^{- 1} {a}_{0} ( {θ}_{0} , {φ}_{0} )} \\ where \text{:} \\ {w}_{MV}^{H} {a}_{0} ( {θ}_{0} , {φ}_{0} ) = 1 ( i . e . , MVDR constraint ) \\ {a}_{0} ( {θ}_{0} , {φ}_{0} ) = antenna steering vector in desired signal direction ( {θ}_{0} , {φ}_{0} ) , dim [ N \times 1 ] \\ {R}_{uu} = Undesired signal array correlation matrix , dim [ N \times N ] = {R}_{ii} + {R}_{vv} \\ {R}_{ii} = Interference / jamming signal array correlation matrix , dim [ N \times N ] \\ {R}_{vv} = Noise signal array correlation matrix , dim [ N \times N ] \qquad ( 5 )$$

For these simulations the directions of the desired signal and interference sources were assumed to be known by the antenna steering algorithm. Only two interference/jamming sources were considered in this simulation at elevation angles of 10°, and away from the desired signal direction in azimuth. The locations of the signals were in spherical coordinates [θ,φ]:
S_{d}(θ,φ)=[45,0] in units of [deg,deg]
J₁(θ,φ)=[80,180] in units of [deg,deg]
J₂(θ,φ)=[80,300] in units of [deg,deg]

While various antenna configurations were tested, results from a 7-element CRPA (representative of 7-element L-band CRPA), and an exemplary 91-element CRPA (representative of a 91-element C-Band CRPA) in a 14″ diameter L-band CRPA footprint are illustrated here.

### Array Factor—2D Elevation and Azimuth Pattern Cuts

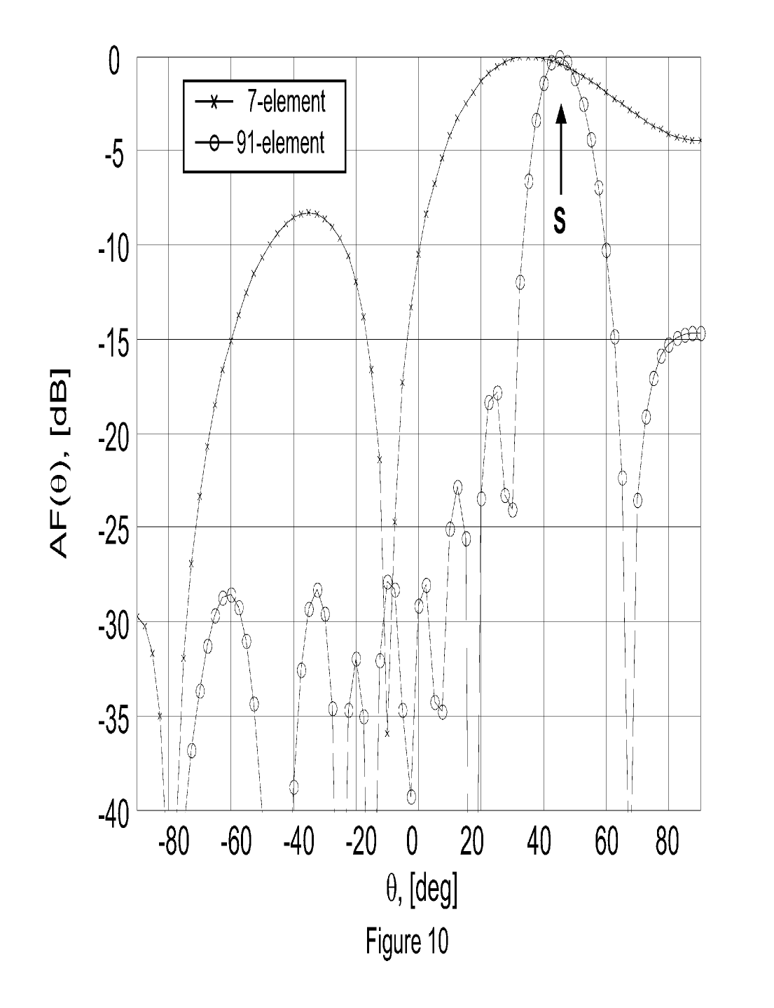

With the circular CRPA array factor simulated in a MVDR fashion, the performance of the pattern can be investigated in various planes. FIG. 10 shows a normalized vertical array factor pattern for the 7-element CRPA and 91-element CRPA in the desired signal elevation plane.

At an elevation angle of 45° the main beams for both arrays can be seen to be directed towards the desired signal (S) direction of 45° in elevation angle. The increased directivity of the 91-element allows for a much narrower (and more accurate beam) to be directed toward the desired signal direction. Both array factors were normalized for comparison. With the 3 dB beamwidth as a performance metric, the 91-element CRPA had an elevation beamwidth of approximately 14° whereas the 7-element CRPA had a much wider elevation beamwidth that is not symmetric with the desired pointing direction, but was approximately 60°. Both array factors are normalized, but the 91-element had 11 dB more directivity, so it actually rises above the 7-element pattern by 11 dB. The increased multipath mitigation of the 91-element may be seen by realizing that the sidelobes of the 91-element pattern are generally lower than the sidelobes of the 7-element CRPA.

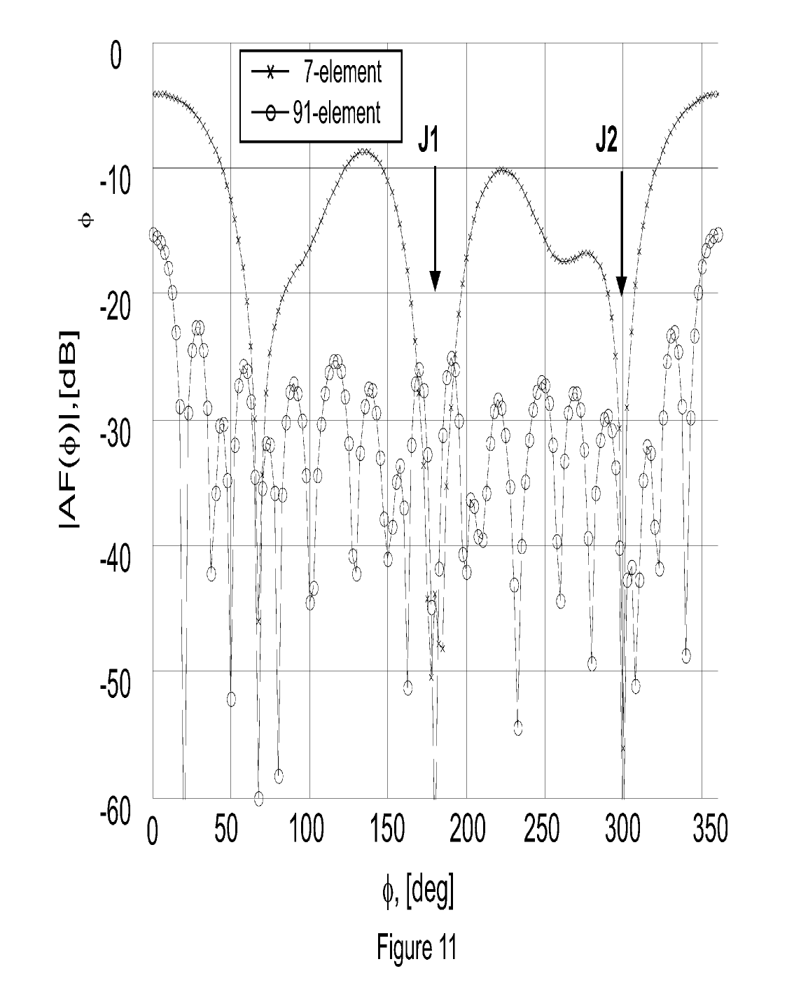

FIG. 11 illustrates the azimuth array factor pattern in the conical plane of the two interference/jammer sources (J1 and J2) at an elevation angle of 10° (i.e., θ=80°. The nulls formed by the MVDR processing can be clearly seen at the jammer azimuth locations of 180° and 300°. These azimuth cuts were extracted from the same normalized simulation, so to equivalently compare the sidelobe performance, the 91-element array factor pattern was bumped up by the increased directivity of 11 dB. When this was done, it was evident that on the average, the multipath mitigation capability of the 91-element CRPA was greater than that of the 7-element CRPA.

### Array Factor—3D Dome Projections

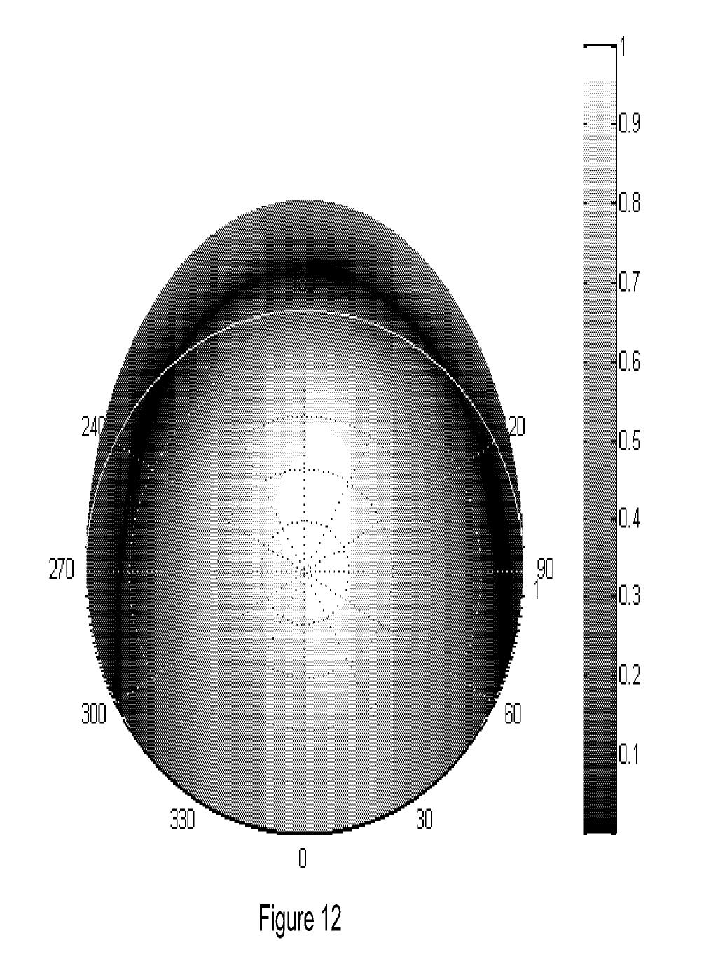

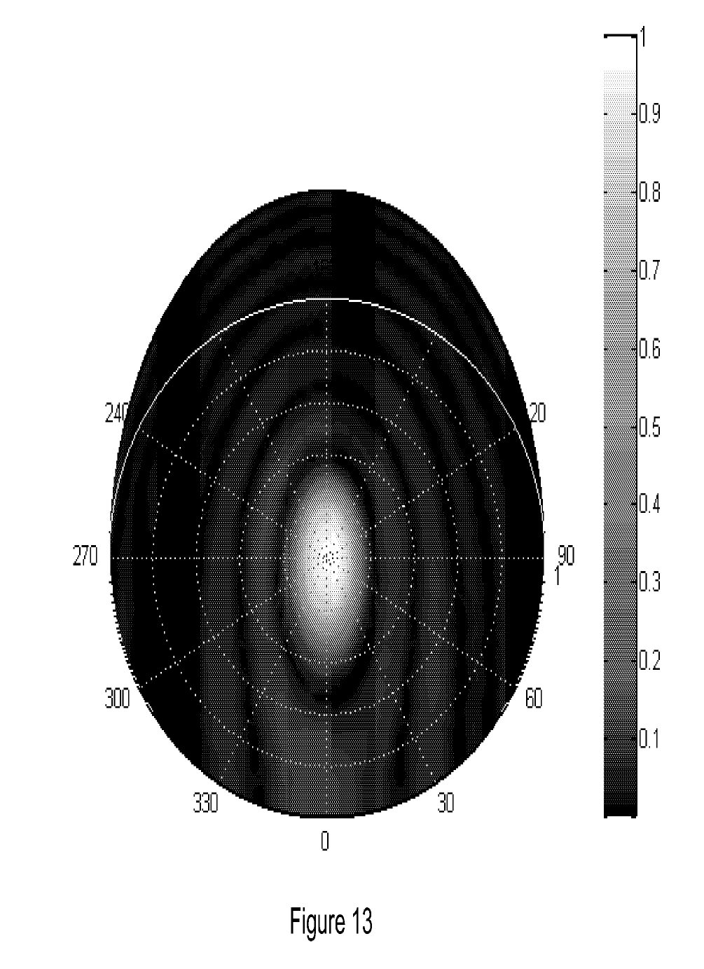

A more qualitative look at the antenna array factor performance can be seen by calculating the array factor in 3D and projecting the directivity onto an upper hemispherical dome surface and color coding the value of the normalized directivity. These plots are shown in FIG. 12 for the 7-element CRPA and FIG. 13 for the 91-element CRPA with the view aspect directed towards the desired signal.

By comparing FIGS. 12 and 13, the much narrow beam pointed in the direction of the desired signal direction is evident.

### Array Factor—Planar Projections

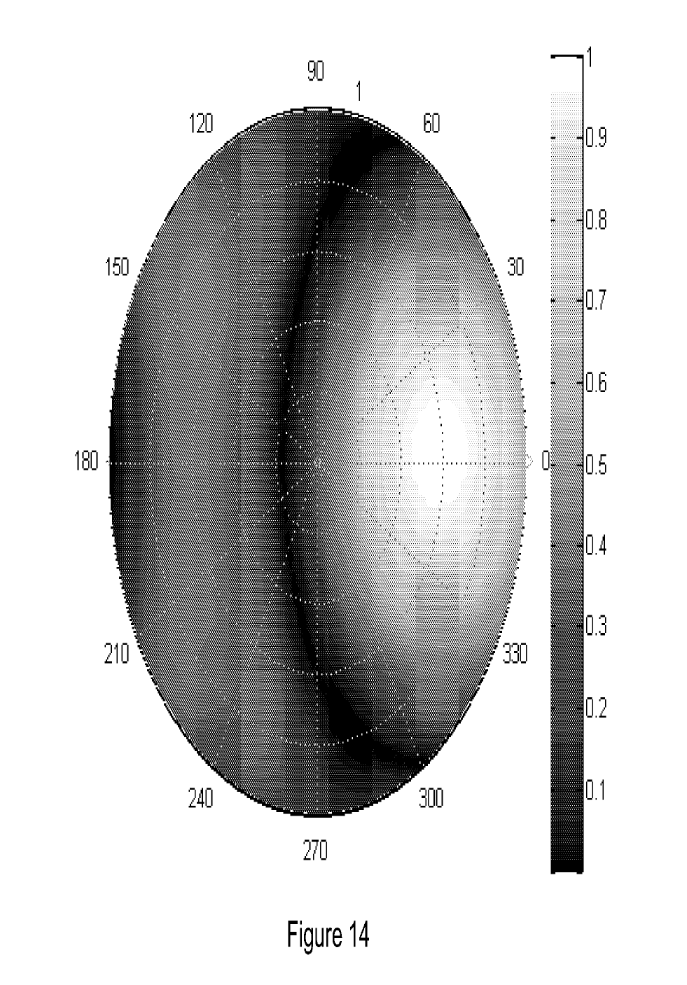

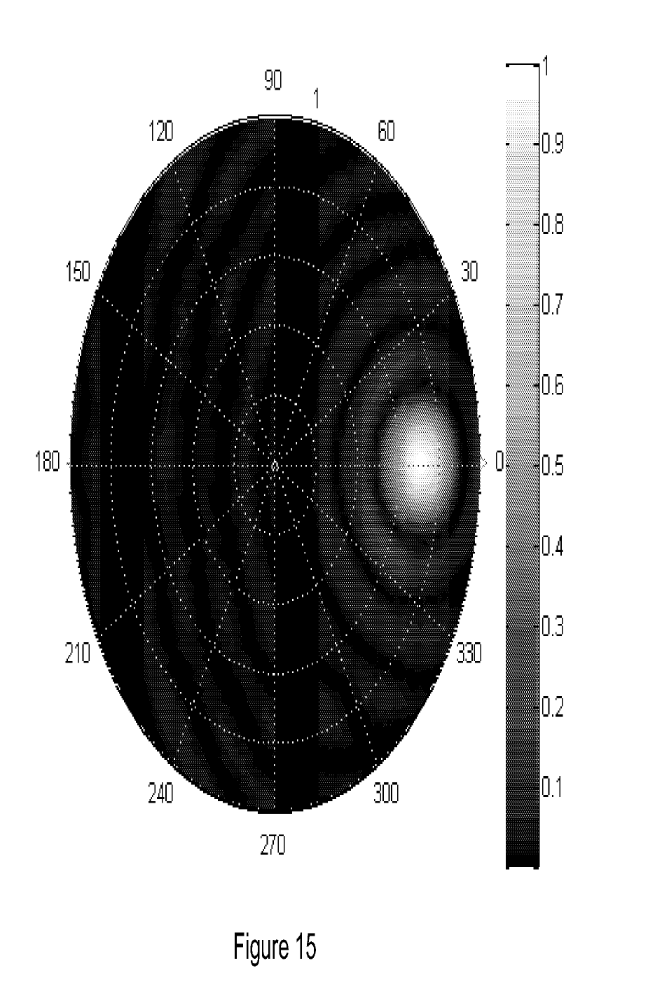

Another way to look at these array factor patterns is to take the directivity values and directly project them from the upper hemi-sphere dome downward onto the local plane. This will allow for a good qualitative assessment of the sidelobe performance. These projections can be seen in FIGS. 14 and 15, for the 7-element and 91-element CRPA, respectively.

FIG. 15 clearly illustrates the superior performance of the 91-element CRPA main beam and overall reduced sidelobes as compared to the 7-element CRPA main beam and sidelobe values. Caution should be used in extracting exact values form FIGS. 14 and 15 because they are in essence a vertical projection downward from a dome surface, and as such, the direction of the main beams and directivity values should not be read directly from the elevation scale because of this non-linear projection as a function of elevation angle. Exact values may be extracted from linear 2D elevation cuts as presented in FIGS. 10 and 11.

### Signal-to-Interference Plus Noise Ratio Performance

Another very important metric in assessing antenna array performance is the signal-to-interference plus noise ratio (SINR). The SINR is calculated in accordance with equation (6), where the desired signal is moved over the entire upper hemisphere (simulated in 2.5° by 2.5° steps), the antenna weights are calculated in a MVDR fashion at each step, and the SINR is calculated.

$$SINR = \frac{{P}_{d}}{{P}_{u}} = \frac{{w}_{MV}^{H} {R}_{dd} {w}_{MV}}{{w}_{MV}^{H} {R}_{uu} {w}_{MV}} \\ where ; \\ {P}_{d} = Power in the desired signal , [ W ] \\ {P}_{u} = Power in the undesired signals , [ W ] \\ {R}_{dd} = Desired signal correlation matrix \\ {R}_{uu} = Undesired signal correlation matrix \qquad ( 6 )$$

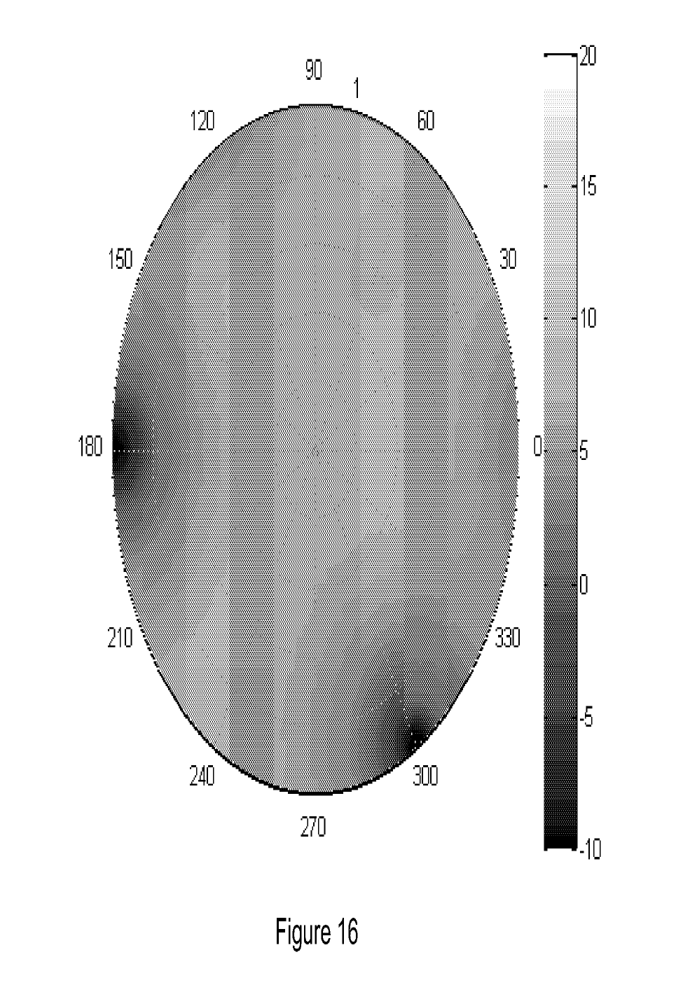

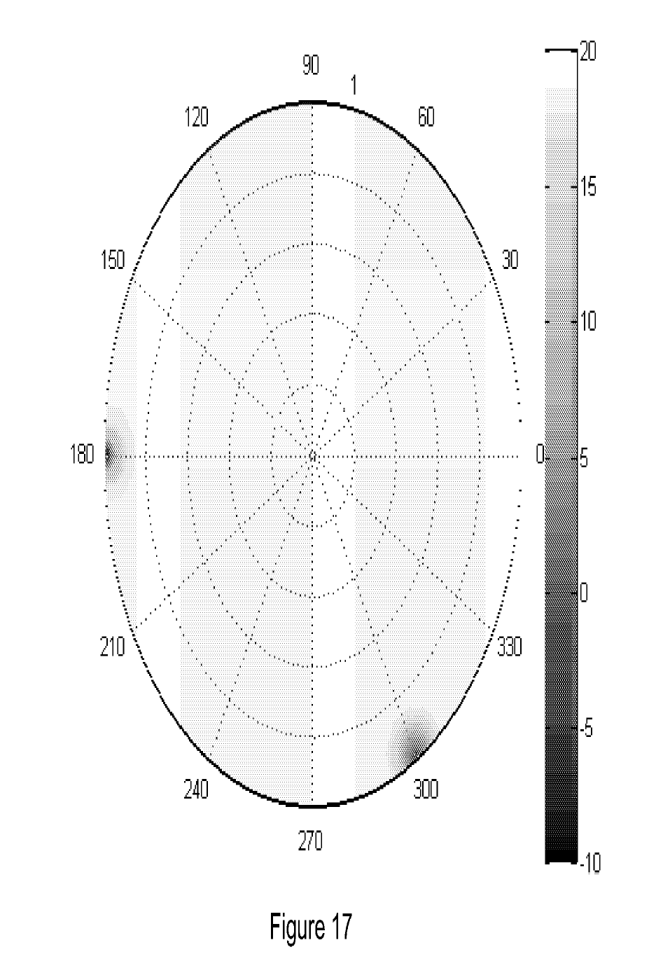

The resulting SINR values, are plotted in FIGS. 16 and 17, for the 7-element CRPA and 91-element CRPA, respectively, and represent the value of SINR that would be obtained with the desired signal at that aspect angle, and the interference/jammer sources fixed at the J1 and J2 locations.

The performance assessment of the 91-element C-Band CRPA with respect to the L-Band CRPA from the data within FIGS. 16 and 17 demonstrated that there was much less effect from the interference sources around the locations of the interference/jamming sources at an elevation angle of 10° and azimuth angles of 180° and 300° (the arbitrary location of the two simulated jamming sources). The SINR was only affected more immediately around the location of the jamming sources. While only two interference sources are illustrated here, the spatial degrees of freedom for each antenna array are relevant. Once the number of interference/jammer sources exceeds N−1 degrees of freedom, the array may not produce desired performance. Thus, once 7 jammers are present for the 7-element CRPA, performance may decline, while the 91-element CPRA may perform well up to a theoretical 90 interference/jamming sources.

### Conclusions for Exemplary C-Band GNSS Antenna Configurations

Using the GPS L1 link as a baseline configuration under a constant SV transmitter power, antenna gain, and similar link loss assumptions, it was shown that the power density prior to the user antenna is the same for the C-Band GNSS as compared to the comparable L-band GNSS. Additionally, if the user antenna has the same effective aperture size, then the same received power at the antenna output may be obtained. Using the existing L-Band user antenna real estate may enable a C-Band CRPA to be implemented in the same size as a FRPA footprint. An ARINC L-Band GNSS footprint will accommodate a 9-element C-Band CRPA and various configurations of 7, 9 and 19-element C-Band CRPAs where presented in military FRPA footprints. Of significant importance is the fact that while the power received for the C-Band GNSS was similar, the increased frequency enables CRPAs to be implemented in existing L-Band FRPA footprints, allowing for interference/jamming mitigation. Furthermore, the increased directivity has added benefits whereby decreasing the signal energy received in directions other than the desired signal direction to provide for both code and carrier multipath mitigation. For military platforms that currently have a 14″ diameter CRPA installed, a 91-element C-Band CRPA may be accommodated that may provide increased directivity by 11 dB and an increase in the theoretical number of interference/jamming sources that may be mitigated up to 90. Again, the increased directivity helps reduce both carrier and code phase multipath whereby the increased directivity generally decreases the signal energy received in directions other than the desired signal direction.

### Exemplary Embodiments of L-Band Antennas

Various exemplary antenna configurations such as for a L-Band GNSS antenna are addressed herein. For one example, the performance aspects of an exemplary 127-element L-Band CRPA for GNSS is compared to the performance of a typical 7-element L-Band CRPA configuration. The focus of the performance comparison is on the antenna array factor, which has a significant effect on the overall performance of the antenna array. For this exemplary embodiment of a 127-element CRPA, the size (i.e., aperture) of the antenna array was allowed to increase to accommodate the increased number of elements, with reference to a 7-element L-Band CRPA. This type of antenna configuration is well suited for a multi-channel digital software defined receiver where digital beam forming signal processing may be performed. The focus of this analysis was on the antenna array factor performance utilizing Matlab® simulations of the array factor in simulated benign and interference/jamming environments. More particularly, the inventors illustrated an exemplary embodiment of a multi-circular ring CRPA configuration for L-Band Global Navigation Satellite Systems (GNSS). For the testing of this embodiment of a multi-circular ring CPRA, the antenna aperture (i.e., size) was allowed to increase to accommodate the multi-circular rings. For this embodiment, a total of 6 rings, plus a center reference element, spaced in radial distance of ½ the GPS L1 center frequency produces 127-elements in a 1.2 meter diameter, 2D planar array configuration. Performance of the 127-element CRPA in terms of the antenna array factor was compared to the array factor performance for a 7-element CRPA (single ring with a center reference element), that is typically implemented in a 14″ diameter size. The performance in terms of size, directivity, number of interference/jamming mitigation capability, beamwidth, main beam distortion, sidelobe suppression for code and carrier phase multipath mitigation, and signal-to-interference-plus-noise (SINR) are compared. Performances in a benign and interference/jamming environment are addressed.

For this illustrated embodiment, the number of elements of 127 is considered substantially more than a smaller number of antenna elements (e.g., 7). These substantially more number of elements provide substantially more spatial degrees of freedom in the CRPA antenna array that may be utilized for additional capabilities of the present invention.

While a particular configuration of a L-Band GNSS antenna was considered, it should again be recognized that other antenna configurations are possible based of the design principles that are presented. For example, other antenna configurations having a different number of antenna elements, a different overall shape, and/or a different effective frequency of operation are possible for various GNSSs.

### Large CRPA Antenna Configuration for an L-Band GNSS

### 127-Element CRPA L-Band Configuration

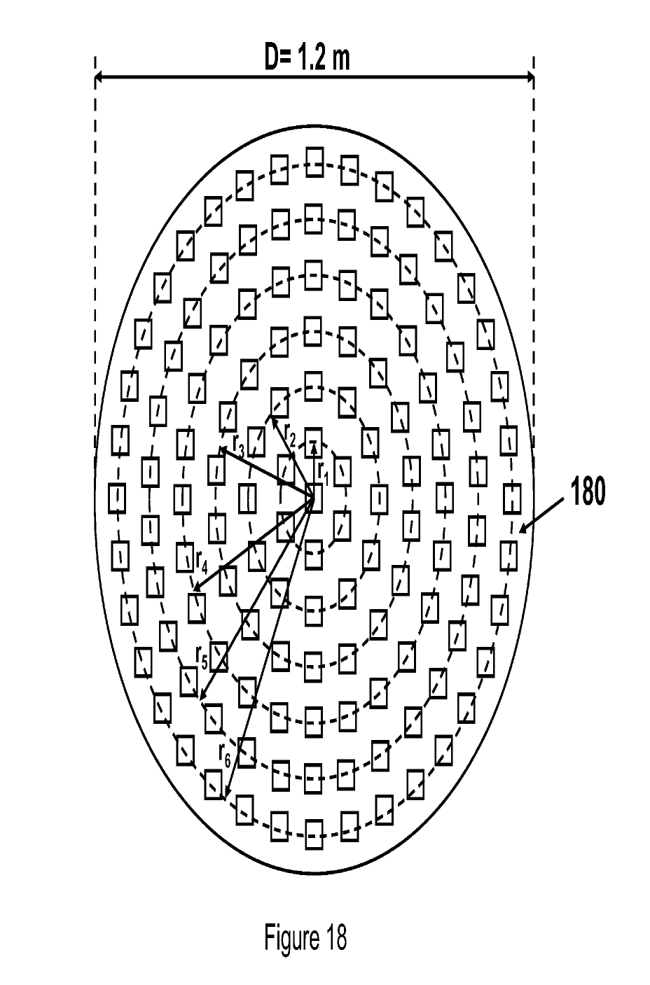

FIG. 18 illustrates the 127-element L-Band CRPA configuration 180. The antenna supports a center reference antenna element with 6 concentric circular rings. In this example, the radius of each ring is in multiples of ½ the GPS L1 wavelength. Antenna elements are shown as a λ/4 by λ/4 square patch elements with radial element spacing, rₙ of nλ/2, where n=the ring number. The number of elements per ring can be represented as Nₙ where n=0, 1, 2, 3, 4, 5, 6 with N represented as the total number of elements in the entire array. For this exemplary 127-element CRPA configuration 180, the total number of elements in each ring is N₀=1 (center reference element), N₁=6, N₂=12, N₃=18, N₄=24, N₅=30, and N₆=36. The number of elements per ring was selected based on the radial distance from the center, the desire to keep the arc length close to a nominal λ/2 and overall symmetry of the array. The total number of elements in the array is the sum of the number of elements per ring, which can be represented as N=N₀+N₁+N₂+N₃+N₄+N₅=1+6+12+18+24+30+36=127. With the radial spacing in multiples of ½ the L1 wavelength, and the number of elements in the design as shown above, all of the element-to-element ring radial distances are 0.52λ_{L1}, and 0.41λ_{L2}. This produced a 2D planar array with dimension of approximately 1.2 m in diameter for the 127-element CRPA. As before, the number of elements may be slightly varied for particular user needs. One of ordinary skill in the art will also recognize that the exact radius, arc length, and element spacing and configuration may be adjusted within scope of the present invention.

### Directivity, Jamming and Degrees of Freedom

As a baseline, briefly consider a GNSS FRPA, which is most often mounted on a ground plane to provide good upper hemisphere coverage. A nominal FRPA typically provides about 0 dBic (dB isotropic for circular polarization) gain at zenith and is not able to produce dynamic nulls in the direction of interference/jammer sources.

A physical antenna array with N spatially separated elements may have N−1 spatial degrees of freedom and may mitigate up to N−1 interference/jammer sources. These interference/jammer sources are considered to be narrowband sources, whereby one narrowband jamming source may be mitigated by each degree of freedom in the antenna array null steering process. It should be noted that advanced signal processing techniques may be implemented to additionally help improve the interference mitigation such as space and time adaptive processing (STAP) or space and frequency adaptive processing (SFAP). These techniques often increase the total degrees of freedom obtained and provide added interference/jamming capability as a function of the scenario conditions and variables.

For a 2D planar array, the directivity is a function of the number of elements in the array, their orientation and aspect angle to the desired pointing direction, and interference sources in an interference/jamming environment. The exact directivity can be calculated numerically based on these variables, but a good approximation for a planar array in a local xy plane is shown above in equation (4).

The directivity increases proportional to the product of the directivity in each orthogonal direction of the planar surface and decreases as the desired signal approaches the horizon for GNSS terrestrial applications (i.e., as the elevation angle decreases).

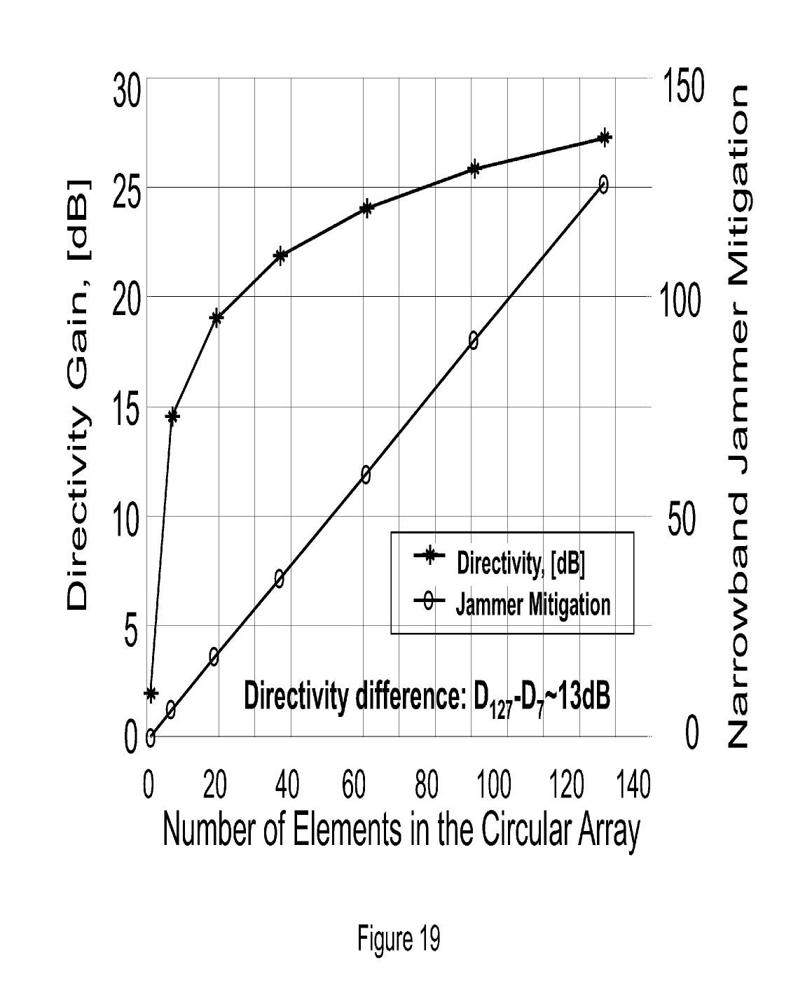

FIG. 19 plots the directivity and the interference/jammer mitigation capability vs. the number of elements in a 2D planar array. The directivity is plotted using Equation (4) for N=7, 19, 37, 61, 91, and 127-element CRPA configurations. For narrowband interference/jamming sources discussed earlier, and for the spatial domain signal processing done here for the array factor, the number of interference/jamming sources to be mitigated can be represented as N−1, where N=total number of elements in the array.

Comparing this exemplary embodiment of 127-element CRPA directivity to the 7-element CRPA directivity, the 127-element CRPA has a theoretical maximum directivity of 27.3 dB at zenith; whereas the 7-element CRPA has a theoretical maximum directivity of 14.5 dB at zenith. Thus, the 127-element CRPA has approximately 13 dB more directivity than the 7-element CRPA. It can be seen from the shape of the directivity curve presented in FIG. 19, that from a pure directivity perspective, returns eventually diminish and may be addressed in other exemplary embodiments.

As for a interference/jamming capability comparison, the exemplary 127-element CRPA may mitigate theoretically 126 interference/jamming sources, whereas the 7-element CRPA may mitigate theoretically 6 interference/jamming sources. Thus, the 127-element may theoretically mitigate 121 more narrowband interference/jamming sources over the 7-element CRPA.

### L-Band Array Factor and Illustrated Performance

To illustrate the performance of the exemplary L-Band 127-element CRPA vs. the 7-element CRPA configuration, the circular planar antenna array factor configurations were simulated in Matlab. In these simulations, the individual antenna element patterns and mutual coupling between each element were not simulated. For reasonable good antenna elements and calibration procedures, these effects on the overall antenna performance may be minimized. For these simulations, a receiver architecture was considered that would perform digital beam forming in a minimum variance (MV) distortion-less response (MVDR) method such that the main beam was pointed in the direction of the desired signal with the antenna steering weights constrained so that the desired signal was not be distorted. This MVDR processing was performed in concert with a digital receiver architecture whereby each receiver channel received the digital data that was processed by the antenna steering algorithm considering the directions of the desired signal (i.e., GNSS SV direction) and undesired signal directions (e.g., interference/jamming sources). The MVDR antenna steering weights were calculated as shown above in equation (5).

For these simulations, the directions of the desired signal and interference/jamming sources were assumed to be known by the antenna steering algorithm. Two basic cases were considered in the simulations. Case I: No Interference/Jamming, and Case II: Interference/Jamming present.

### Case I: No Interference/Jamming

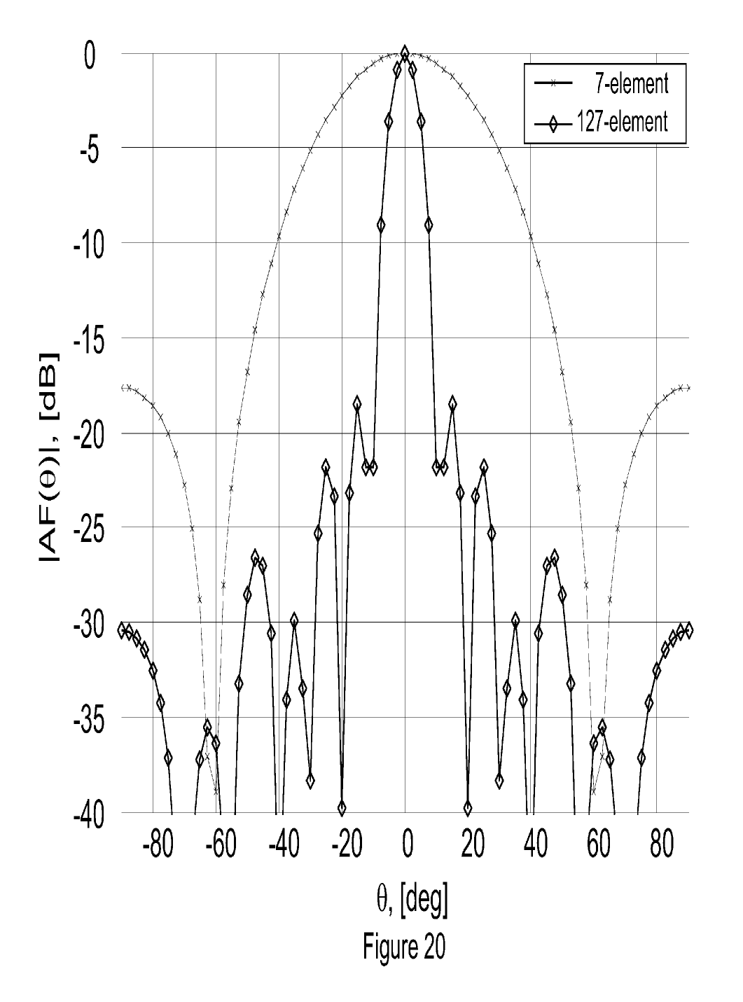

To investigate the CRPA antenna array performance for the exemplary 127-element vs. 7-element configurations, no interference/jamming was simulated initially. As a baseline, the desired signal (S_{d}) was placed at zenith, i.e., spherical coordinates, S_{d}(θ,φ)=[0,90] in units of [deg,deg]; thus the desired signal was simulated at an elevation angle of 90° and azimuth angle of 90°. FIG. 20 illustrates the CRPA array factors for the 127-element CRPA and the 7-element CRPA with the desired signal at an elevation angle of 90°. It was seen that both main beams are pointed straight up with symmetric beams centered at zenith. The 3 dB beamwidth for the 127-element CRPA was categorized as [−5, +5]=10°, i.e., 3 dB down 5° to the left of the commanded desired signal direction and 3 dB down 5° to the right of the commanded desired signal direction, for an overall 3 dB beamwidth of 10°. The 3 dB beamwidth for the 7-element CRPA was categorized as [−23, +23]=46°, i.e., 3 dB down 23° to the left of the commanded desired signal direction and 3 dB down 26° to the right of the commanded desired signal direction, for an overall 3 dB beamwidth of 46°. Thus, the 127-element array had a much more narrow beamwidth, with its increased directivity, relative to the 7-element array. Additionally, the 127-element provided much better sidelobe suppression for multipath mitigation. Several items were considered when assessing the additional multipath mitigations. First, both array factors were normalized in the traces shown in FIG. 20. Because of the increased directivity of the 127-element array, if the 127-element trace was “bumped up” by the increased directivity of 13 dB, then the multipath into the antennas at angles other than the desired signal was lower for the 127-element array, than for the 7-element array, thereby mitigating multipath at those angles. Since this was signal attenuation at the antenna level, both code and carrier phase multipath were mitigated. It was noted that since there were different array configurations, the nulls (not induced from interference/jamming source steering) were in different locations; thus, in the null of a 7-element array, the 127-element may not have a null at that location, and may have a higher response (i.e., not as much multipath mitigation at that specific angle). While different metrics can be used to assess the multipath mitigation, with the multipath mitigation over all elevation angles, it is evident from FIG. 20 that the 127-element CRPA provided significantly better multipath mitigation than the 7-element CRPA.

As for the 3 dB beamwidth in the azimuth direction of the 127-element and 7 element array factors, both arrays had the same “azimuth” 3 dB beamwidth. This was essentially the 3 dB beamwidth at broadside (i.e., at an elevation angle of 90°), i.e., 10° for the 127-element CRPA and 46° for the 7-element CRPA.

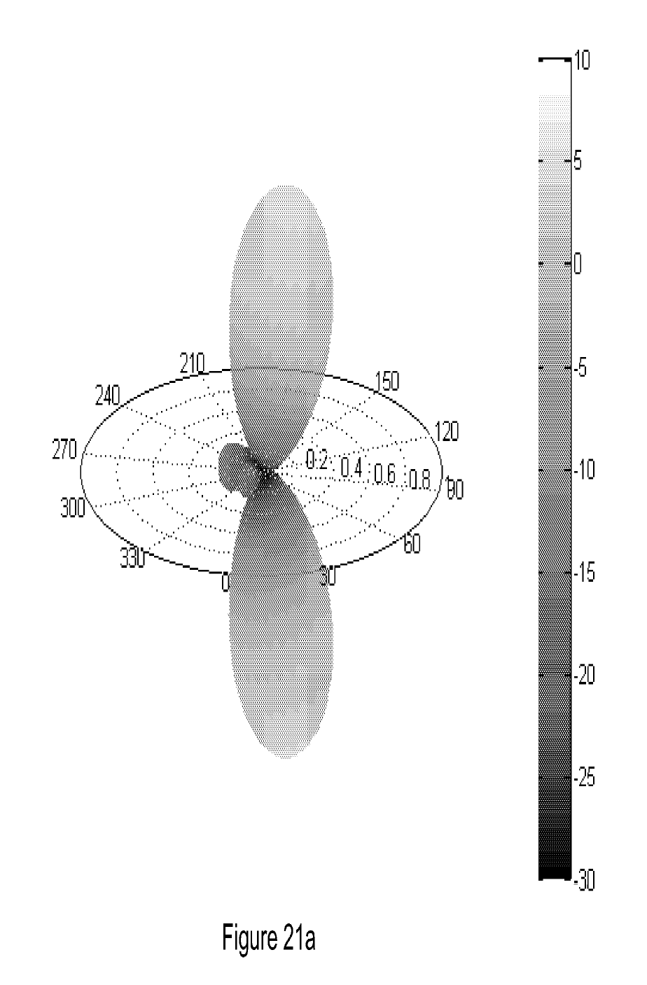

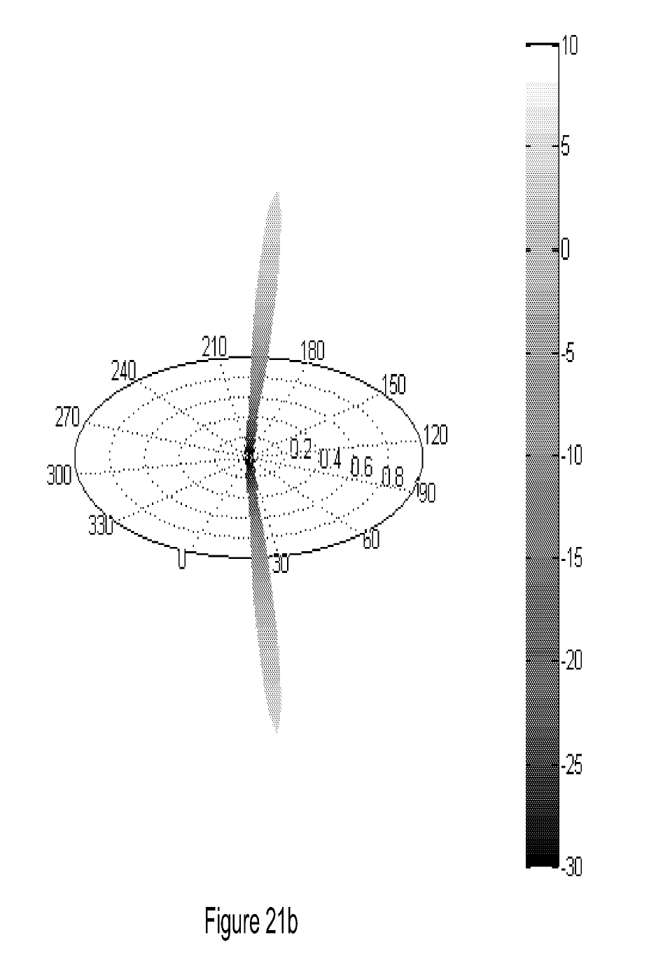

As the elevation angle to the desired signal decreases, the main beam direction pointed in the direction of the commanded desired signal direction. FIGS. 21a and 21b provides a qualitative 3D perspective of the 7-element and 127-element array factor pattern respectively, for a desired signal at an elevation angle of 80°, i.e., S_{d}(8,4)=[10,90]. For both FIGS. 21a and 21b, the view is off axis at a view angle of spherical coordinates: [θ=70,φ=10].

For both of the array factors in FIGS. 21a and 21b, the array factor below the horizontal plane was not suppressed to illustrate the entire array factor. In a realizable CRPA antenna, the antenna elements may be placed on a planar ground plane, which would suppress the lower part of the array factor; however, it was productive not to suppress it in this testing to illustrate the performance of the array factor as the elevation angle decreases.

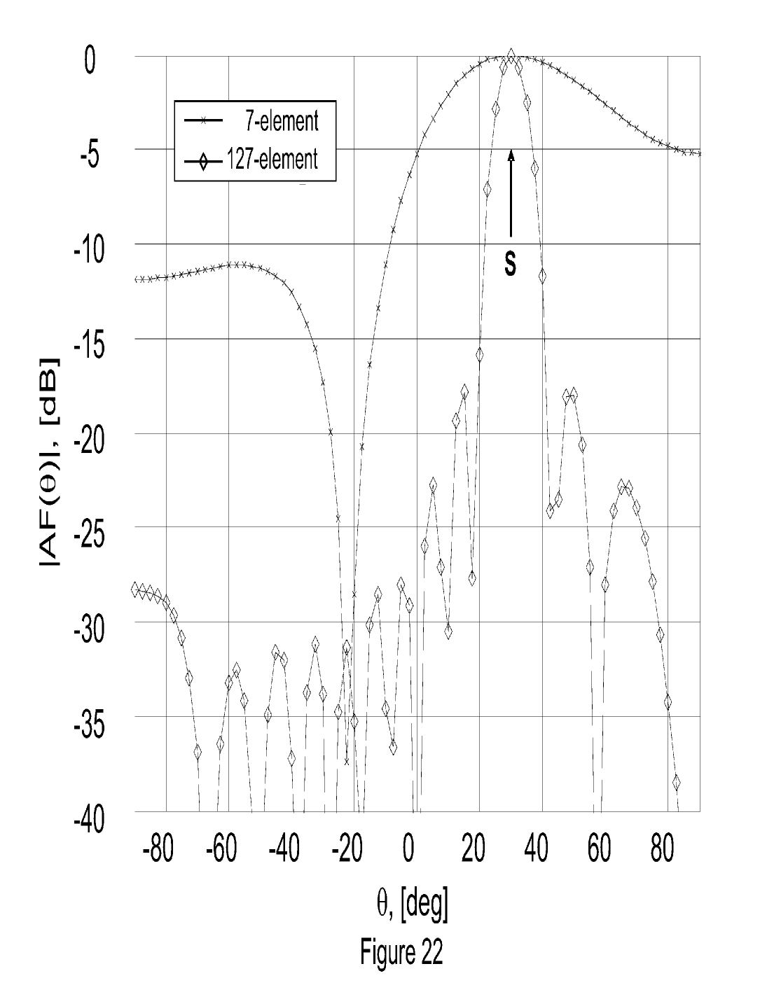

As the elevation angle to the desired signal decreases even more to an elevation angle of 60°, i.e., S_{d}(θ,φ)=[30,90], the main beam direction again pointed in the direction of the commanded desired signal direction, but exhibited some asymmetric shape of the beamwidth for the 7-element CRPA. This can be observed in the 2D elevation array factor pattern illustrated in FIG. 22. While there was a small amount of asymmetry in the overall 127-element CRPA array factor shape, there was negligible asymmetry in the main beam. This was not true for the 7-element CPRA array factor as there was substantial asymmetry in the 7-element CRPA array factor main beam. To once again characterize the 3 dB beamwidth of both array factors, the 3 dB beamwidth for the 127-element CRPA was categorized as [−5, +5]=10°, while the 3 dB beamwidth for the 7-element CRPA was categorized as [−24, +33]=57°, i.e., 3 dB down 24° to the left of the commanded desired signal direction and 3 dB down 33° to the right of the commanded desired signal direction, for an overall 3 dB beamwidth of 57°. Thus, the 127-element array had a much more narrower beamwidth, with its increased directivity, and did not become asymmetric about the commanded direction, but the 7-element array became asymmetric and broader about the commanded signal direction. Additionally, the 127-element provided much better sidelobe suppression for multipath mitigation, especially at the horizon because the beamwidth was much narrower.

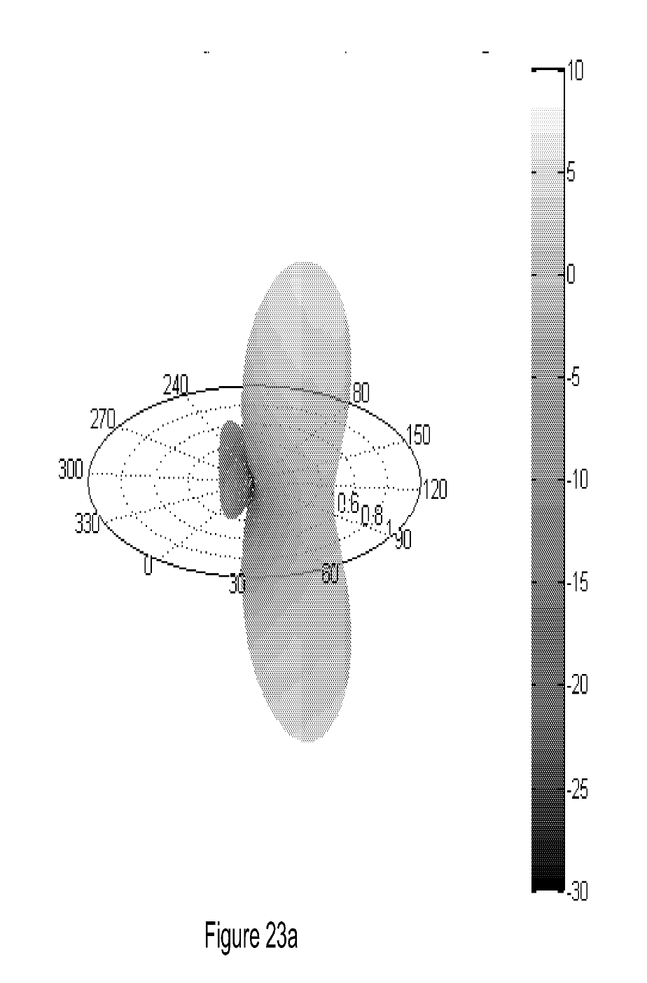

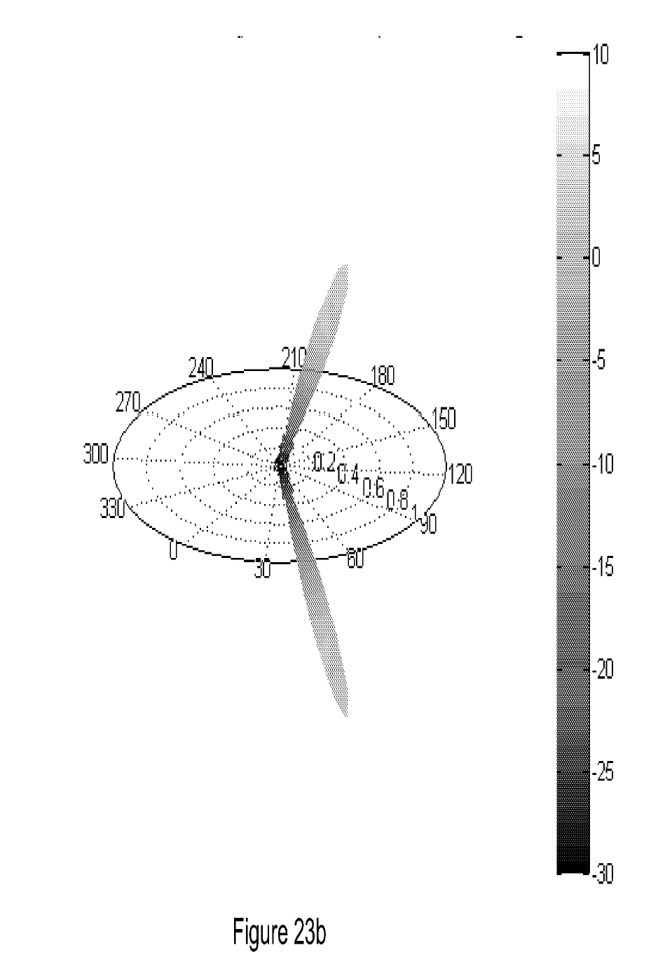

In 3D, the asymmetry of the 7-element array factor can be observed in FIG. 23a. By not suppressing the lower part of the array factor, the “coming together” of the upper and lower hemisphere beams is apparent. Again, the array factor below the horizon may be suppressed by the planar ground plane where the antenna elements are mounted. However, the performance was still not being enhanced by the array factor at this point for the 7-element array factor. As for the exemplary 127-element array factor performance illustrated in FIG. 23b for the desired signal elevation angle of 60°, the narrow beamwidth was still able to be maintained and the two array factor beams did not come together.

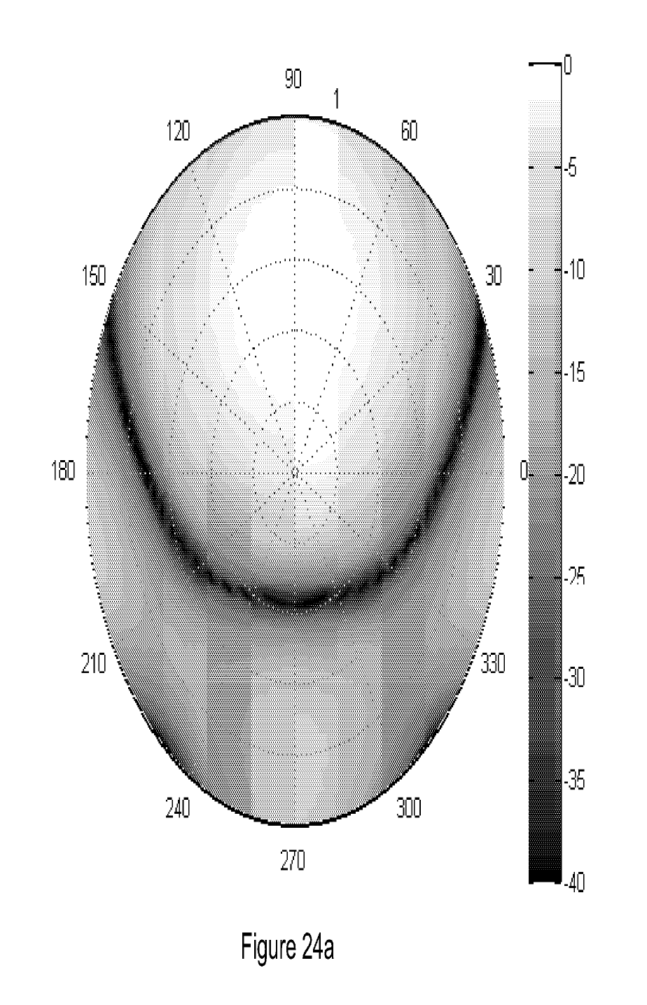

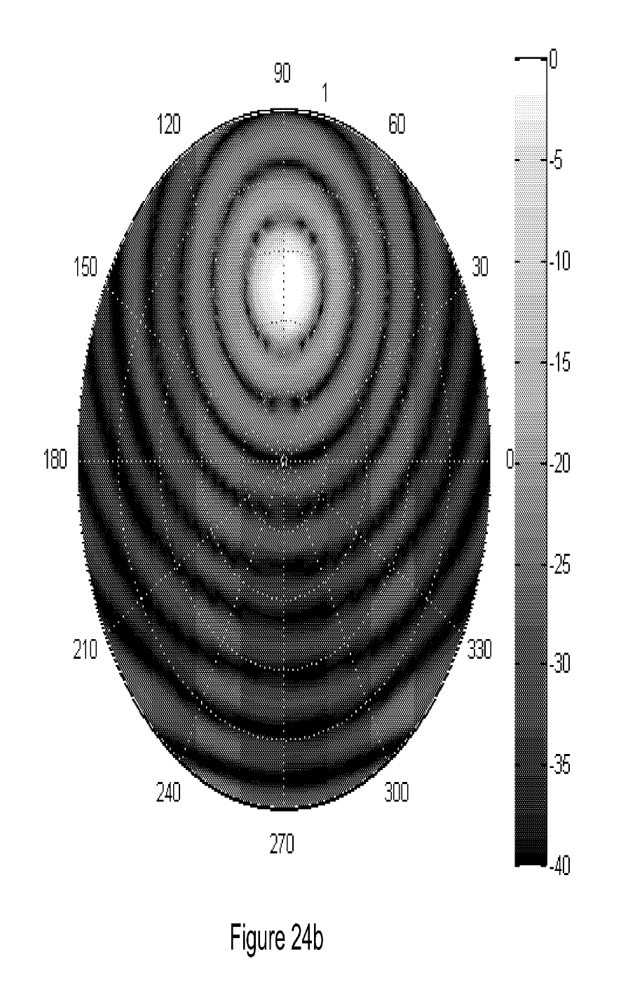

In addition, to further illustrate the beam and sidelobe performance of these CRPA array factors, it was enlightening to take the normalized array factor directivity gain, project this value onto a sphere, encode the normalized directivity gain, and plot it in units of dB. FIGS. 24a and 24b illustrate this normalized directivity gain.

The array factor for the 7-element CRPA points the main beam in the direction of the desired signal (max value of 0 dB) and the roll off of the gain can be seen. This type of representation was very effective in visualizing, quantitatively, the gain performance not only in the main beam direction, but especially in directions other than the main beam; in essence, 3D. The circular nulling was an artifact of the beamsteering algorithm with the geometry of the circular array configuration and the direction of the desired signal.

The superior performance of the exemplary 127-element beamsteering can be seen in FIG. 24b, where the narrow beamwidth is illustrated at the 0 dB point, and the excellent sidelobe suppression over the upper hemisphere is shown by the rippling sidelobes, which are significantly suppressed, as indicated on the bar scale.

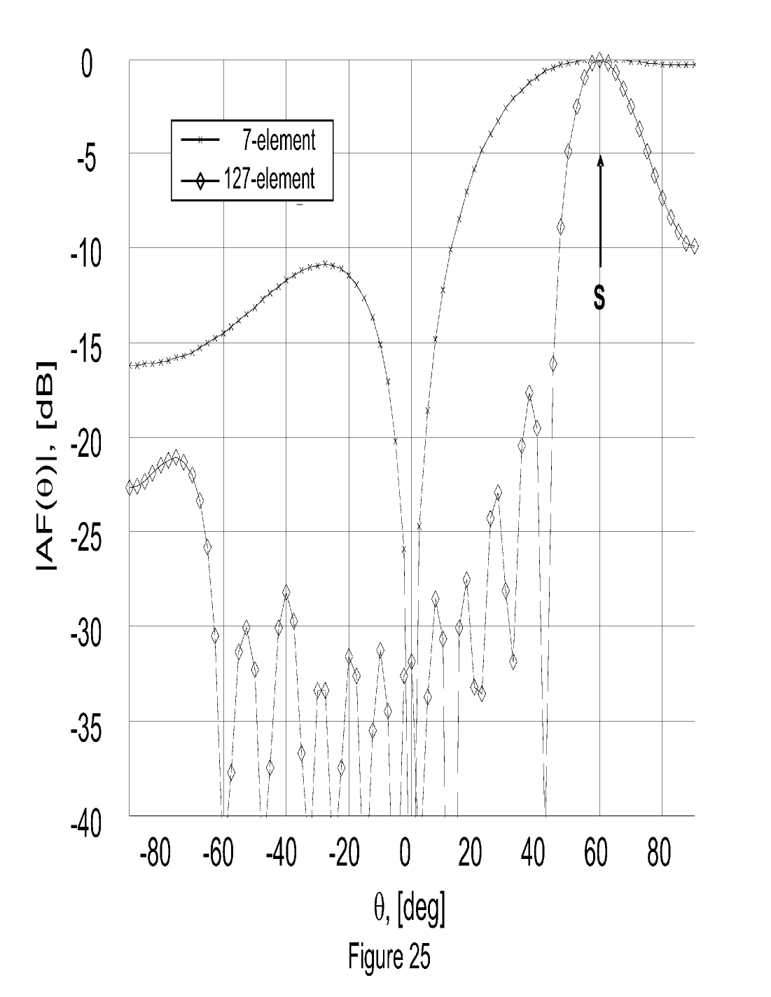

Now as the elevation angle continues to decrease, similar characteristics were observed in the array factors. At an elevation angle of 30°, i.e., S_{d}(θ,φ)=[60,90], the main beam direction again pointed in the direction of the commanded desired signal direction, but the directivity gets much poorer for the 7-element array factor to the point where we cannot even calculate a 3 dB beamwidth in the elevation plane for the 7-element CRPA array factor; see FIG. 25. At this elevation angle, some asymmetric shape of the main beam, and change in the beamwidth for the 127-element CRPA, began to occur but may be addressed in other exemplary embodiments.

To once again characterize the 3 dB beamwidth of both array factors, the 3 dB beamwidth for the 127-element CRPA was categorized as [−8, +11]=19°, while the 3 dB beamwidth for the 7-element CRPA cannot even be calculated because it had flattened out at the horizon. Thus, the exemplary 127-element array still maintained a reasonable narrow beamwidth (19°) with its increased directivity whereas the 7-element array factor gain in the direction of the desired signal direction was essentially the same as it was at the horizon. Once again, this exemplary embodiment of a 127-element configuration provided much better sidelobe suppression for multipath mitigation.

As the elevation angle continues to decrease down to 10° i.e., S_{d}(θ,φ)=[80,90], both of the array factors flatten out at the horizon because of the cos(0) term in equation (4) and due to the number of elements in the array (i.e., the 7-element flattens out first as the elevation angle decreases, much sooner than the 127-element array).

As for the 3 dB beamwidth in the azimuth direction for the 127-element and 7 element array factors, both arrays maintained their respective 3 dB beamwidth as the elevation angle decreases. This was essentially the 3 dB beamwidth at broadside (i.e., at an elevation angle of 90°); 10° for the 127-element CRPA and 46° for the 7-element CRPA.

### Case II: With Interference/Jamming

With the baseline performance of the 127-element and 7-element CRPA characterized in a benign environment, an interference/jamming environment was then simulated. A wide variety of interference/jamming scenarios were simulated, and a representative scenario is addressed here. To illustrate the interference/jamming performance, a total of 5 narrowband interference/jamming sources were placed at the local horizon, and centered about the desired signal azimuth angle, 100 times the desired signal strength, spaced as illustrated below. The locations of the signals in spherical coordinates [0,0] were:

S_{d}(θ,φ)=[60,90] in units of [deg,deg]

J₁(θ,φ)=[90,90] in units of [deg,deg]

J₂(θ,φ)=[90,90−5] in units of [deg,deg].

J₃(θ,φ)=[90,90+5] in units of [deg,deg]

J₄(θ,φ)=[90,90−10] in units of [deg,deg].

J₅(θ,φ)=[90,90+10] in units of [deg,deg]

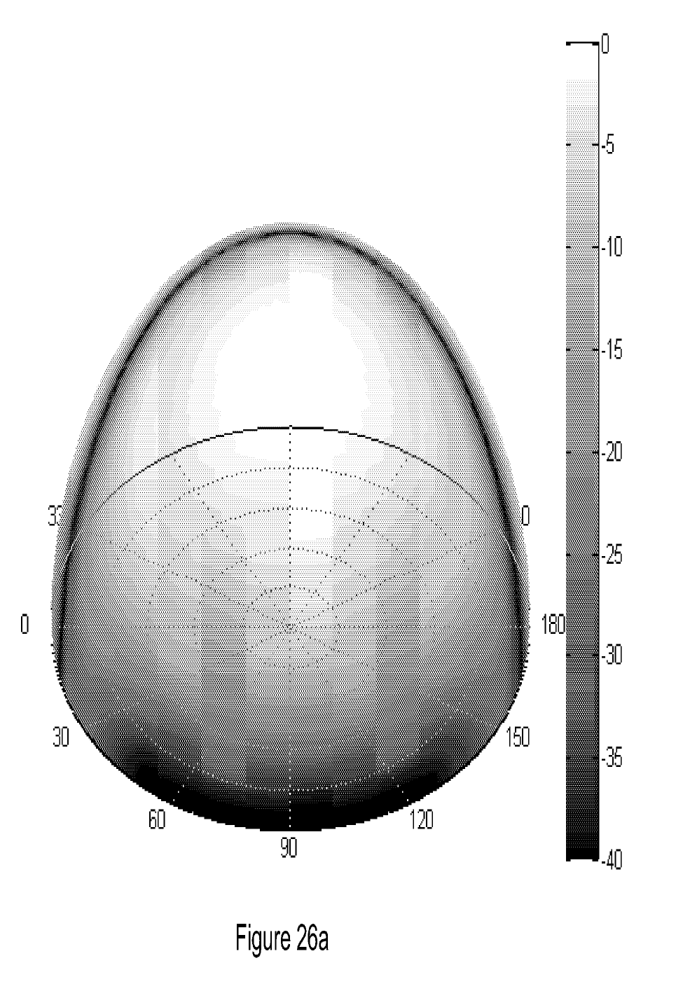

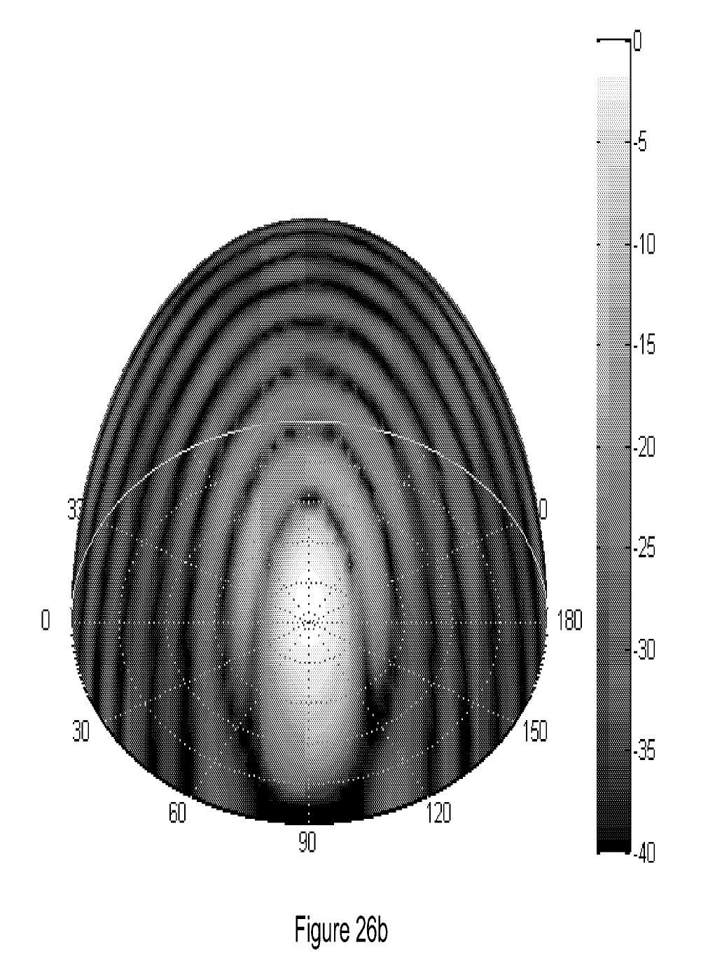

When the MVDR beamsteering algorithm is subjected to the above scenario of signal and interference/jammer positions and levels, the CRPA array factor performance is obtained. FIG. 26a is a 3D illustration of the 7-element CRPA array normalized directivity gain, encoded, and projected onto the surface of a sphere, in units of dB. The relatively large main beam of the CPRA is evident by the directivity gain of 0 dB, as well as the nulls placed at the horizon centered about the desired signal direction in azimuth, as listed above. While the nulls are placed at the interference/jammer source locations, the low gain response was present over a much broader region of space because of the limited degrees of freedom of the 7-element CRPA, which was directly related to the beamwidth and the number of elements in the array. The desired signal was simulated at an elevation angle of 30°, and the view angle of FIG. 26a, was in the direction of this commanded signal direction, but the maximum directivity gain was above, in elevation, the desired signal direction. Since the interference sources are “relatively close” to the desired signal direction, given a certain number of degrees of freedom of the antenna array (i.e., directly related to the beamwidth and number of elements in the array), the interference/jammer sources affected the main beam direction and gain. This had a negative impact on the processing of the desired signal, even under a MVDR constraint, in this interference/jamming environment.

FIG. 26b illustrates the exemplary 3D 127-element CRPA array performance in the interference/jamming scenario as outlined above (same as for the 7-element CRPA shown in FIG. 26a). Again the normalized directivity gain is encoded, projected onto the upper-hemisphere, and plotted in units of dB. The narrowbeam of the 127-element array was readily apparent by the normalized directivity gain of 0 dB, and the excellent sidelobe suppression over the rest of the hemispherical. Also, good gain direction accuracy of the main beam in the direction of the desired signal was obtained. Thus, there was no significant main beam distortion resulting from the interference/jammer source locations and levels. This was because the exemplary 127-element configuration had more elements, more degrees of freedom, a narrower beamwidth, and these factors produced less effect on the main beam by the interference/jammer sources. Also, the overall effect of the interference/jammer sources at their locations on the 127-element array factor directivity gain is relevant. The 127-element array may place very narrow nulls on the interference/jammer source locations, which have less overall effect on the gain at angles other than where the interference/jammer sources are located at. The additional degrees of freedom with the substantial number of antenna elements allow the placement of nulls over a specific geographic region where interference signals are estimated to be. These estimations may be based on data or where the interference sources may be anticipated. For example, the placement of a null just above the horizon (e.g., θ=85°) every so many degrees (e.g., 5° in φ), may provide additional protection to interference sources expected to arrive from angles just above the horizon over a specific geographic region. Additionally the extra degrees of freedom may be spaced in “two layers” to place nulls just above the horizon (e.g., θ=80 and 85°) every so many degrees (e.g., 10° in φ) to provide additional protection from interference sources expected to arrive from angles just above the horizon. Furthermore, the extra degrees of freedom may be spaced to place nulls in a specific geographic region (e.g., θ=60 and 90°, and over φ from 0 to) 120° every so many degrees (e.g., 6° in φ) to provide additional protection from interference sources expected to arrive from angles over a specific geographic region. One of ordinary skill in the art will recognize that other combinations of geographic regions may be formed with the substantial degrees of freedom provided by the antenna array.

The additional degrees of freedom with the substantial number of antenna elements allow the placement of nulls over a specific geographic region where multipath signals are estimated to be. These estimations may be based on data or where the multipath sources may be anticipated. For example, the placement of a null just above the horizon (e.g., θ=85°) every so many degrees (e.g., 5° in φ) may provide additional protection from multipath signals expected to arrive from angles just above the horizon over a specific geographic region, that may be due to diffractions off the ground plane or user structure, as well as positive elevation angle multipath. Additionally the extra degrees of freedom may be spaced in “two layers” to place nulls just above the horizon (e.g., θ=80 and 85°) every so many degrees (e.g., 10° in φ) to provide additional protection to interference sources expected to arrive from angles over a geographic region. Furthermore, the extra degrees of freedom may be spaced to place nulls in a specific geographic region (e.g., θ=60 and 90°, and over φ from 0 to 120°) every so many degrees (e.g., 6° in φ) to provide additional protection from multipath sources expected to arrive from angles over a specific geographic region, due to multipath. Additionally, the extra degrees of freedom may be spaced to place a tight cluster of nulls in a specific geographic region (e.g., θ=−120, −125, and −130°, and over 0 from 90, 95, and 100°) every so many degrees (e.g., 2° in φ) to provide additional protection to multipath sources expected to arrive at angles over a specific geographic region, due to multipath; this multipath may be received from a reflection body, below the user platform local horizon, where the desired signal may be in a particular direction of (e.g., θ=35 and) φ=95°. One of ordinary skill in the art will recognize that other combinations of geographic regions may be formed with the substantial degrees of freedom provided by the antenna array.

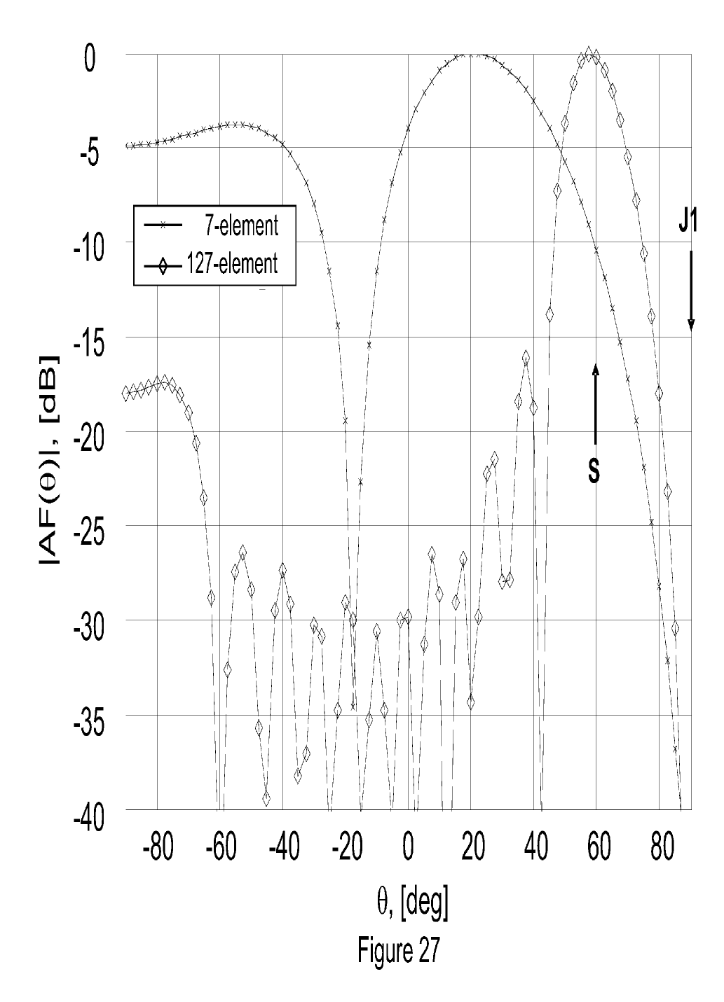

The effect on the main beams for the 127-element and 7-element CRPA array factors, with the 5 interference/jammer sources as outlined above can be very clearly observed in FIG. 27, which is a 2D elevation cut in the plane of the desired signal at S_{d}(θ,φ)=[60,90] and the first interference/jammer source J₁(θ,φ)=[90,90]. The 127-element array factor trace in FIG. 27 shows there was very little beam distortion resulting from the 5 interference/jammer sources, while there was significant beam distortion in the elevation plane for the 7-element CRPA array factor from the 5 interference/jammer sources. This beam distortion produced an attenuation of the desired signal, at an elevation angle of 30°, by 10 dB.

As was seen in the benign CRPA array performances, the azimuth beamwidths were consistently maintained, for the 5 interference/jammer source scenario illustrated here, where the exemplary 127-element CRPA had a 10° beamwidth, and the 7-element CRPA had a 46° beamwidth.

### Signal-to-Interference Plus Noise Ratio Performance

An important metric in assessing a CRPA array performance is the SINR. The SINR is calculated in accordance with equation (6).

The desired signal was moved over the entire upper hemisphere (simulated in 2.5° by 2.5° steps), and at each spatial step, the MVDR antenna weights were calculated in accordance with equation (5), and the SINR was calculated using equation (6). In these calculations, the 5 interference/jamming signals were present as outlined above.

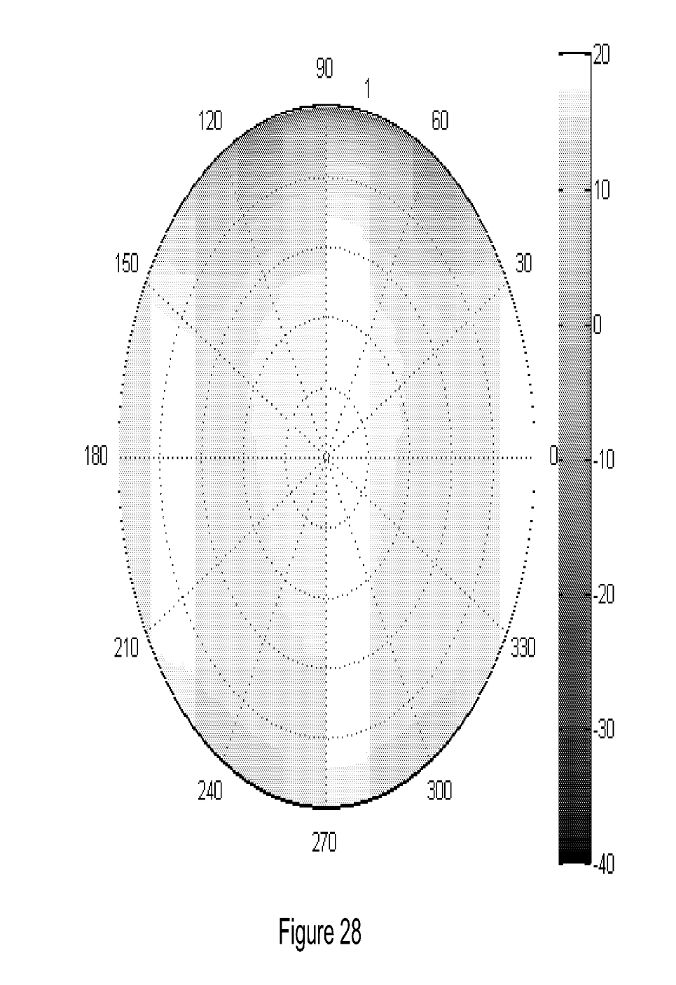

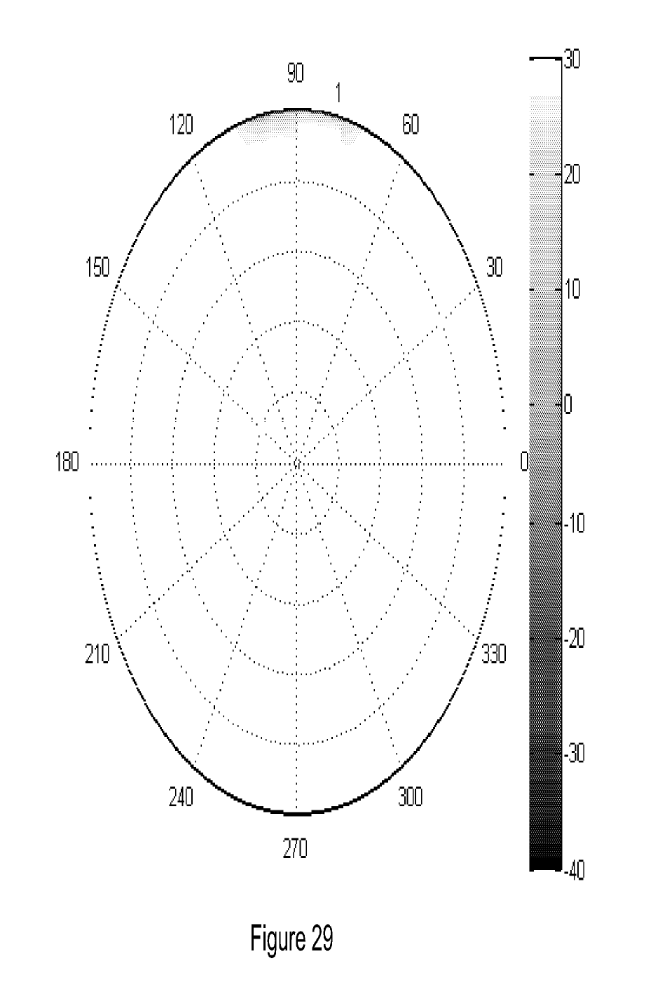

The resulting SINR values are plotted in FIGS. 28 and 29, for the 7-element CRPA and 127-element CRPA, respectively. The values of SINR are encoded, and plotted in units of dB. These SINR values represent the SNIR value that would be obtained with the desired signal at that aspect angle, and with the 5 interference/jammer sources fixed at locations and values documented above.

As illustrated in comparing the SINR for the 7-element CRPA and the 127-element CRPA, the exemplary 127-element CPRA provided for much better SINR over the entire upper hemisphere. Furthermore, there was less SINR reduction around the location of the 5 interference/jammer sources located at the horizon center about the azimuth angle of the desired signal, i.e., 4=90.

As stated before, one of ordinary skill in the art would recognize that the L-Band GNSS CRPA antenna configurations illustrated above may be applied to other GNSSs that may operate in other frequency bands (e.g., S-Band, C-Band, etc.) within the scope of the present invention.

### Conclusions for Exemplary L-Band GNSS Antenna Configurations

An exemplary embodiment illustrated the array factor performance of a 127-element L-Band CRPA and compared the array factor performance to a 7-element CRPA for certain GNSS applications. While the 127-element antenna configuration was larger (˜1.2 m diameter) compared to a typical 7-element CRPA (˜14″ diameter) there were several performance advantages that may be used for certain high value GNSS users. An increase in the theoretical directivity gain of 13 dB (˜27.3 dB for the 127-element CRPA vs. 14.5 dB for the 7-element CRPA) allowed for a much narrower beamwidth (at broadside 10° for the 127-element CRPA vs. 46° for the 7-element CRPA). This increased directivity gain may be useful to help mitigate code and carrier phase multipath, as well as produce less effect on the main beam performance as the elevation angle to the desired signal direction decreases.

The exemplary 127-element CRPA may theoretically mitigate 121 more narrowband interference/jamming sources than the 7-element CRPA (126 for the 127-element CRPA vs. 6 for the 7-element CRPA).

When a limited number of interference/jammer sources (i.e., 5) were placed at the horizon, centered about the desired signal azimuth direction when the desired signal was at an elevation angle of 30°, it was shown that the interference/jamming sources produced significant distortion in the 7-element CRPA elevation array factor, while the 127-element CRPA array factor saw minimal effects.

When the signal-to-interference plus noise ratio (SINR) was calculated for the limited 5 interference/jammer scenario, the SINR for the 127-element CRPA was illustrated to be significantly better over the entire upper hemisphere as compared to that of the 7-element CRPA SINR.

While the exemplary 127-element CRPA may be physically larger than the 7-element CRPA, its increased elements provide an array factor with higher performance in terms of increased directivity, overall reduction in code and carrier multipath, increase in interference/jamming sources that may be mitigated, reduced effects from interference/jamming sources in close proximity to the main beam, and increased SINR, and the exemplary 127-element CRPA added robustness for high value GNSS receiver systems.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A C-band Global Navigation Satellite Systems (GNSS) antenna comprising:
a center antenna element having a center;
4 co-planar side antenna elements, each side antenna element having a center and positioned so that the centers of the side antenna elements are co-planar with and a first distance from the center of the center element;
4 co-planar corner antenna elements, each corner antenna element having a center and positioned so that the centers of the corner antenna elements are co-planar with and a second (diagonal) distance from the center of the center element; and
a ground plane substantially parallel to a plane of the centers of the antenna elements and separated from the antenna elements by a dielectric layer;
wherein the second (diagonal) distance is about equal to or greater than the first distance.

2. The antenna of claim 1, wherein:
the first distance is about one half a wavelength of a center of a frequency of operation of the antenna; and
the second (diagonal) distance is about 0.707 of a wavelength of the center of the frequency of operation of the antenna.

3. The antenna of claim 2, wherein the antenna elements fit within the size dimensions defined within the ARINC 743, or equivalent, specification.

4. A C-band Global Navigation Satellite Systems (GNSS) antenna comprising:
a center antenna element having a center;
a first set of about 6 coplanar antenna elements, each antenna element of the first set of antenna elements having a center in a co-planar arrangement with respect to the center of the center element and a first distance from the center of the center element; and
a ground plane substantially parallel to the antenna element plane and separated from the antenna elements by a dielectric layer.

5. The antenna of claim 4, wherein the centers of each of the antenna elements in the first set of antenna elements are spaced at substantially equal angles about the center element.

6. The antenna of claim 4, wherein the first distance is one half wavelength of a center frequency of a frequency of operation of the antenna.

7. The antenna of claim 4, further comprising:
a second set of about 12 coplanar antenna elements, each antenna element of the second set of antenna elements having a center in a co-planar arrangement with respect to the center of the center element and a second distance from the center of the center element;
the centers of each of the antenna elements in the second set of antenna elements are spaced at substantially equal angles about the center element; and
the second distance is about one wavelength of a center frequency of a frequency of operation of the antenna.

8. The antenna of claim 7, further comprising:
a third set of about 18 coplanar antenna elements, each antenna element of the third set of antenna elements having a center in a co-planar arrangement with respect to the center of the center element and a third distance from the center of the center element;
the centers of each of the antenna elements in the third set of antenna elements are spaced at substantially equal angles about the center element; and
the third distance is about one and one-half wavelengths of the center frequency of the frequency of operation of the antenna.

9. The antenna of claim 8, further comprising:
a fourth set of about 24 coplanar antenna elements, each antenna element of the fourth set of antenna elements having a center in a co-planar arrangement with respect to the center of the center element and a fourth distance from the center of the center element;
the centers of each of the antenna elements in the fourth set of antenna elements are spaced at substantially equal angles about the center element; and
the fourth distance is about two wavelengths of the center frequency of the frequency of operation of the antenna.

10. The antenna of claim 9, further comprising:
a fifth set of about 30 coplanar antenna elements, each antenna element of the fifth set of antenna elements having a center in a co-planar arrangement with respect to the center of the center element and a fifth distance from the center of the center element;
the centers of each of the antenna elements in the fifth set of antenna elements are spaced at substantially equal angles about the center element; and
the fifth distance is about two and one-half wavelengths of the center frequency of the frequency of operation of the antenna.

11. A method of receiving a C-band Global Navigation Satellite Systems (GNSS) signal, the method comprising utilizing an antenna in such a way as to mitigate multipath and other interfering signals.

12. A Global Navigation Satellite Systems (GNSS) antenna comprising:
a center antenna element having a center;
a first set of about 6 coplanar antenna elements, each antenna element of the first set of antenna elements having a center in a co-planar arrangement with respect to the center of the center element and a first distance from the center of the center element;
a second set of about 12 coplanar antenna elements, each antenna element of the second set of antenna elements having a center in a co-planar arrangement with respect to the center of the center element and a second distance from the center of the center element; and
a ground plane substantially parallel to the antenna element plane and separated from the antenna elements by a dielectric layer;
wherein the centers of each of the antenna elements in each set of antenna elements are spaced at substantially equal angles about the center element; and
wherein the centers of each of the antenna elements are spaced at a fractional distance of a center frequency wavelength from the centers of the closest adjacent elements.

13. The antenna of claim 12, further comprising:
a third set of about 18 coplanar antenna elements, each antenna element of the third set of antenna elements having a center in a co-planar arrangement with respect to the center of the center element and a third distance from the center of the center element; and
the ground plane is substantially parallel to the antenna element plane and separated from the antenna elements by the dielectric layer;
wherein the centers of each of the antenna elements in each set of antenna elements are spaced at substantially equal angles about the center element; and
wherein the centers of each of the antenna elements are spaced at a fractional distance of the center frequency wavelength from the centers of the closest adjacent elements.

14. The antenna of claim 13, further comprising:
a fourth set of about 24 coplanar antenna elements, each antenna element of the fourth set of antenna elements having a center in a co-planar arrangement with respect to the center of the center element and a fourth distance from the center of the center element;
the ground plane is substantially parallel to the antenna element plane and separated from the antenna elements by the dielectric layer;
wherein the centers of each of the antenna elements in each set of antenna elements are spaced at substantially equal angles about the center element; and
wherein the centers of each of the antenna elements are spaced at a fractional distance of the center frequency wavelength from the centers of the closest adjacent elements.

15. The antenna of claim 14, further comprising:
a fifth set of about 30 coplanar antenna elements, each antenna element of the fifth set of antenna elements having a center in a co-planar arrangement with respect to the center of the center element and a fifth distance from the center of the center element; and
the ground plane is substantially parallel to the antenna element plane and separated from the antenna elements by the dielectric layer;
wherein the centers of each of the antenna elements in each set of antenna elements are spaced at substantially equal angles about the center element; and
wherein the centers of each of the antenna elements are spaced at a fractional distance of the center frequency wavelength from the centers of the closest adjacent elements.

16. The antenna of claim 15, further comprising:
a sixth set of about 36 coplanar antenna elements, each antenna element of the sixth set of antenna elements having a center in a co-planar arrangement with respect to the center of the center element and a fifth distance from the center of the center element; and
the ground plane is substantially parallel to the antenna element plane and separated from the antenna elements by the dielectric layer;
wherein the centers of each of the antenna elements in each set of antenna elements are spaced at substantially equal angles about the center element; and
wherein the centers of each of the antenna elements are spaced at a fractional distance of the center frequency wavelength from the centers of the closest adjacent elements.

17. A method of receiving a Global Navigation Satellite Systems (GNSS) signal, the method comprising utilizing degrees of freedom to place multiple nulls over specific geographic regions, where interference signals are expected to be received over a geographic region.

18. A method of receiving a Global Navigation Satellite Systems (GNSS) signal, the method comprising utilizing degrees of freedom to place multiple nulls over specific geographic regions, where multipath signals are expected to be received over a geographic region.

19. A method of receiving a Global Navigation Satellite Systems (GNSS) signal, the method comprising utilizing degrees of freedom to reduce gain over specific geographic regions, to minimize distortion in antenna pattern in a direction of a desired signal when interference signals would otherwise distort the antenna pattern response.
